(19) United States
(12) Patent Application Publication
(10) Pub. No.: US 2024/0357431 A1
(43) Pub. Date: Oct. 24, 2024

(54) COMMUNICATION BASED ON CHANNEL RASTER

(71) Applicant: LG ELECTRONICS INC., Seoul (KR)

(72) Inventors: Markus PETTERSSON, Seoul (KR); Sangwook LEE, Seoul (KR); Seonwook KIM, Seoul (KR)

(73) Assignee: LG ELECTRONICS INC., Seoul (KR)

(21) Appl. No.: 18/700,070

(22) PCT Filed: Oct. 21, 2022
(86) PCT No.: PCT/KR2022/016144

§ 371 Date: Apr. 10, 2024

Related U.S. Application Data
(60) Provisional application No. 63/270,519, filed on Oct. 21, 2021.
(60) Provisional application No. 63/309,010, filed on Feb. 11, 2022.
(60) Provisional application No. 63/334,176, filed on Apr. 24, 2022.

(51) Int. Cl. H04W 28/20; H04L 5/00; H04W 72/0453

(52) U.S. Cl. CPC H04W 28/20; H04L 5/0048; H04W 72/0453

(57) ABSTRACT

According to the present disclosure, there is provided a UE operating in a wireless communication system. The UE comprises: at least one transceiver; at least one processor; and at least one computer memory operably connectable to the at least one processor and storing instructions that, based on being executed by the at least one processor, perform operations comprising: identifying RF channel position based on RF reference frequency in operating band n263.

### CROSS-REFERENCE TO RELATED APPLICATION(S)

This application is the National Stage filing under 35 U.S.C. 371 of International Application No. PCT/KR2022/016144, filed on Oct. 21, 2022, which claims the benefit of U.S. Provisional Application Nos. 63/270,519 filed on Oct. 21, 2021, 63/309,010 filed on Feb. 11, 2022, and 63/334,176 filed on Apr. 24, 2022, the contents of which are all hereby incorporated by reference herein in their entireties.

### TECHNICAL FIELD

The present disclosure relates to mobile communication.

### BACKGROUND

3rd generation partnership project (3GPP) long-term evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Work has started in international telecommunication union (ITU) and 3GPP to develop requirements and specifications for new radio (NR) systems. 3GPP has to identify and develop the technology components needed for successfully standardizing the new RAT timely satisfying both the urgent market needs, and the more long-term requirements set forth by the ITU radio communication sector (ITU-R) international mobile telecommunications (IMT)-2020 process. Further, the NR should be able to use any spectrum band ranging at least up to 100 GHz that may be made available for wireless communications even in a more distant future.

The NR targets a single technical framework addressing all usage scenarios, requirements and deployment scenarios including enhanced mobile broadband (eMBB), massive machine-type-communications (mMTC), ultra-reliable and low latency communications (URLLC), etc. The NR shall be inherently forward compatible.

NR operating bands in Frequency Range (FR) 2 was introduced. Among NR operating bands in FR 2, operating band n263 was newly introduced. However, in prior art, channel raster for n263 band was not defined.

For example, basic concept of channel raster based on 60 kHz separation between two adjacent raster locations was merely defined.

This dense raster leads to very high number or channel raster locations that UE needs to support. This very high number or channel raster locations creates problems, such as unnecessary overhead of the UE, especially on FR 2-2 frequency range, in which the n263 band included, where wide channel band widths are used on 14 GHz wide operating band.

Therefore, channel raster, New Radio Absolute Radio Frequency Channel Number (NR-ARFCN) for operating band n263 needs to be defined.

### SUMMARY

Accordingly, a disclosure of the present specification has been made in an effort to solve the aforementioned problem.

In accordance with an embodiment of the present disclosure, a disclosure of the present specification provides a UE operating in a wireless communication system. The UE comprises: at least one transceiver; at least one processor; and at least one computer memory operably connectable to the at least one processor and storing instructions that, based on being executed by the at least one processor, perform operations comprising: identifying RF channel position based on RF reference frequency in operating band n263.

According to a disclosure of the present disclosure, the above problem of the related art is solved.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

### BRIEF DESCRIPTION OF THE DRAWINGS

FIG. 1 shows an example of a communication system to which implementations of the present disclosure is applied.

FIG. 2 shows an example of wireless devices to which implementations of the present disclosure is applied.

FIG. 3 shows an example of a wireless device to which implementations of the present disclosure is applied.

FIG. 4 is a diagram illustrating an example of an SS block in NR.

FIG. 5 is a diagram illustrating an example of beam sweeping in the NR.

FIG. 6 shows an example of SSB to which implementations of the present disclosure can be applied.

FIG. 7 shows an example of SI acquisition procedure to which implementations of the present disclosure can be applied.

FIG. 8 shows an example of contention-based random access (CBRA) to which implementations of the present disclosure can be applied.

FIG. 9 shows an example of contention-free random access (CFRA) to which implementations of the present disclosure can be applied.

FIG. 10 shows a concept of threshold of the SSB for RACH resource association to which implementations of the present disclosure can be applied.

FIG. 11 illustrates an example of channel raster to resource element mapping.

FIG. 12 illustrates an example of 50 MHz raster to support channel bandwidth according to the present disclosure.

FIG. 13 illustrates an example of co-existence configuration case with 802.11ad channel #1.according to the present disclosure.

FIG. 14 illustrates an example of co-existence configuration case with 802.11ad channel #2.according to the present disclosure.

FIG. 15 illustrates an example of selected GSCN location for 100 MHz channels and 400 MHz channels according to the present disclosure.

FIG. 16 illustrates an example of SSB center frequency locations within 100 MHz CBW according to the present disclosure.

FIG. 17 illustrates an example of SSB center frequency locations within 400 MHz CBW according to the present disclosure.

FIG. 18a illustrates an example of channels based on channel raster according to the second example of the present disclosure.

FIG. 18b illustrates an example of GSCN selection according to the second example of the present disclosure.

FIG. 19 illustrates an example of SSB center frequency locations within 100.8 MHz CBW according to the present disclosure.

FIG. 20 illustrates an example of SSB center frequency locations within 403.2 MHz CBW according to the present disclosure.

FIG. 21 illustrates an example of operations of a UE according to an embodiment of the present disclosure.

### DETAILED DESCRIPTION

The following techniques, apparatuses, and systems may be applied to a variety of wireless multiple access systems. Examples of the multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multicarrier frequency division multiple access (MC-FDMA) system. CDMA may be embodied through radio technology such as universal terrestrial radio access (UTRA) or CDMA2000. TDMA may be embodied through radio technology such as global system for mobile communications (GSM), general packet radio service (GPRS), or enhanced data rates for GSM evolution (EDGE). OFDMA may be embodied through radio technology such as institute of electrical and electronics engineers (IEEE) 802.11 (Wi-Fi), IEEE 802.16 (WiMAX), IEEE 802.20, or evolved UTRA (E-UTRA). UTRA is a part of a universal mobile telecommunications system (UMTS). 3rd generation partnership project (3GPP) long term evolution (LTE) is a part of evolved UMTS (E-UMTS) using E-UTRA. 3GPP LTE employs OFDMA in DL and SC-FDMA in UL. Evolution of 3GPP LTE includes LTE-A (advanced), LTE-A Pro, and/or 5G NR (new radio).

For convenience of description, implementations of the present disclosure are mainly described in regards to a 3GPP based wireless communication system. However, the technical features of the present disclosure are not limited thereto. For example, although the following detailed description is given based on a mobile communication system corresponding to a 3GPP based wireless communication system, aspects of the present disclosure that are not limited to 3GPP based wireless communication system are applicable to other mobile communication systems.

For terms and technologies which are not specifically described among the terms of and technologies employed in the present disclosure, the wireless communication standard documents published before the present disclosure may be referenced.

In the present disclosure, “A or B” may mean “only A”, “only B”, or “both A and B”. In other words, “A or B” in the present disclosure may be interpreted as “A and/or B”. For example, “A, B or C” in the present disclosure may mean “only A”, “only B”, “only C”, or “any combination of A, B and C”.

In the present disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In the present disclosure, “at least one of A and B” may mean “only A”, “only B” or “both A and B”. In addition, the expression “at least one of A or B” or “at least one of A and/or B” in the present disclosure may be interpreted as same as “at least one of A and B”.

In addition, in the present disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the present disclosure may mean “for example”. In detail, when it is shown as “control information (PDCCH)”, “PDCCH” may be proposed as an example of “control information”. In other words, “control information” in the present disclosure is not limited to “PDCCH”, and “PDCCH” may be proposed as an example of “control information”. In addition, even when shown as “control information (i.e., PDCCH)”, “PDCCH” may be proposed as an example of “control information”.

Technical features that are separately described in one drawing in the present disclosure may be implemented separately or simultaneously.

Although not limited thereto, various descriptions, functions, procedures, suggestions, methods and/or operational flowcharts of the present disclosure disclosed herein can be applied to various fields requiring wireless communication and/or connection (e.g., 5G) between devices.

Hereinafter, the present disclosure will be described in more detail with reference to drawings. The same reference numerals in the following drawings and/or descriptions may refer to the same and/or corresponding hardware blocks, software blocks, and/or functional blocks unless otherwise indicated.

Although user equipment (UE) is illustrated in the accompanying drawings by way of example, the illustrated UE may be referred to as a terminal, mobile equipment (ME), and the like. In addition, the UE may be a portable device such as a notebook computer, a mobile phone, a PDA, a smart phone, a multimedia device, or the like, or may be a non-portable device such as a PC or a vehicle-mounted device.

Hereinafter, the UE is used as an example of a wireless communication device (or a wireless device, or a wireless apparatus) capable of wireless communication. An operation performed by the UE may be performed by a wireless communication device. A wireless communication device may also be referred to as a wireless device, a wireless device, or the like.

A base station, a term used below, generally refers to a fixed station that communicates with a wireless device. The base station may be reffered to as another term such as an evolved-NodeB (eNodeB), an evolved-NodeB (eNB), a BTS (Base Transceiver System), an access point (Access Point), gNB (Next generation NodeB), etc.

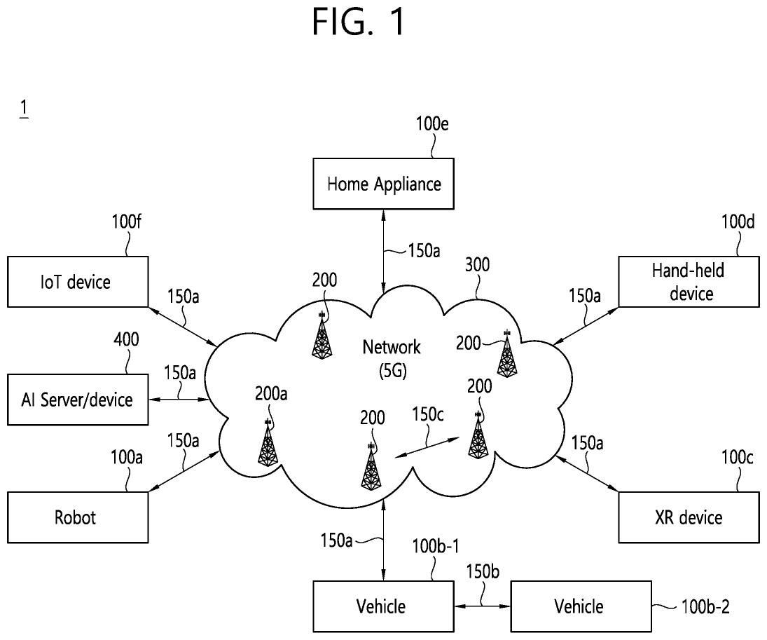

FIG. 1 shows an example of a communication system to which implementations of the present disclosure is applied.

The 5G usage scenarios shown in FIG. 1 are only exemplary, and the technical features of the present disclosure can be applied to other 5G usage scenarios which are not shown in FIG. 1.

Three main requirement categories for 5G include (1) a category of enhanced mobile broadband (eMBB), (2) a category of massive machine type communication (mMTC), and (3) a category of ultra-reliable and low latency communications (URLLC).

Partial use cases may require a plurality of categories for optimization and other use cases may focus only upon one key performance indicator (KPI). 5G supports such various use cases using a flexible and reliable method.

eMBB far surpasses basic mobile Internet access and covers abundant bidirectional work and media and entertainment applications in cloud and augmented reality. Data is one of 5G core motive forces and, in a 5G era, a dedicated voice service may not be provided for the first time. In 5G, it is expected that voice will be simply processed as an application program using data connection provided by a communication system. Main causes for increased traffic volume are due to an increase in the size of content and an increase in the number of applications requiring high data transmission rate. A streaming service (of audio and video), conversational video, and mobile Internet access will be more widely used as more devices are connected to the Internet. These many application programs require connectivity of an always turned-on state in order to push real-time information and alarm for users. Cloud storage and applications are rapidly increasing in a mobile communication platform and may be applied to both work and entertainment. The cloud storage is a special use case which accelerates growth of uplink data transmission rate. 5G is also used for remote work of cloud. When a tactile interface is used, 5G demands much lower end-to-end latency to maintain user good experience. Entertainment, for example, cloud gaming and video streaming, is another core element which increases demand for mobile broadband capability. Entertainment is essential for a smartphone and a tablet in any place including high mobility environments such as a train, a vehicle, and an airplane. Other use cases are augmented reality for entertainment and information search. In this case, the augmented reality requires very low latency and instantaneous data volume.

In addition, one of the most expected 5G use cases relates a function capable of smoothly connecting embedded sensors in all fields, i.e., mMTC. It is expected that the number of potential Internet-of-things (IoT) devices will reach 204 hundred million up to the year of 2020. An industrial IoT is one of categories of performing a main role enabling a smart city, asset tracking, smart utility, agriculture, and security infrastructure through 5G.

URLLC includes a new service that will change industry through remote control of main infrastructure and an ultra-reliable/available low-latency link such as a self-driving vehicle. A level of reliability and latency is essential to control a smart grid, automatize industry, achieve robotics, and control and adjust a drone.

5G is a means of providing streaming evaluated as a few hundred megabits per second to gigabits per second and may complement fiber-to-the-home (FTTH) and cable-based broadband (or DOCSIS). Such fast speed is needed to deliver TV in resolution of 4K or more (6K, 8K, and more), as well as virtual reality and augmented reality. Virtual reality (VR) and augmented reality (AR) applications include almost immersive sports games. A specific application program may require a special network configuration. For example, for VR games, gaming companies need to incorporate a core server into an edge network server of a network operator in order to minimize latency.

Automotive is expected to be a new important motivated force in 5G together with many use cases for mobile communication for vehicles. For example, entertainment for passengers requires high simultaneous capacity and mobile broadband with high mobility. This is because future users continue to expect connection of high quality regardless of their locations and speeds. Another use case of an automotive field is an AR dashboard. The AR dashboard causes a driver to identify an object in the dark in addition to an object seen from a front window and displays a distance from the object and a movement of the object by overlapping information talking to the driver. In the future, a wireless module enables communication between vehicles, information exchange between a vehicle and supporting infrastructure, and information exchange between a vehicle and other connected devices (e.g., devices accompanied by a pedestrian). A safety system guides alternative courses of a behavior so that a driver may drive more safely drive, thereby lowering the danger of an accident. The next stage will be a remotely controlled or self-driven vehicle. This requires very high reliability and very fast communication between different self-driven vehicles and between a vehicle and infrastructure. In the future, a self-driven vehicle will perform all driving activities and a driver will focus only upon abnormal traffic that the vehicle cannot identify. Technical requirements of a self-driven vehicle demand ultra-low latency and ultra-high reliability so that traffic safety is increased to a level that cannot be achieved by human being.

A smart city and a smart home/building mentioned as a smart society will be embedded in a high-density wireless sensor network. A distributed network of an intelligent sensor will identify conditions for costs and energy-efficient maintenance of a city or a home. Similar configurations may be performed for respective households. All of temperature sensors, window and heating controllers, burglar alarms, and home appliances are wirelessly connected. Many of these sensors are typically low in data transmission rate, power, and cost. However, real-time HD video may be demanded by a specific type of device to perform monitoring.

Consumption and distribution of energy including heat or gas is distributed at a higher level so that automated control of the distribution sensor network is demanded. The smart grid collects information and connects the sensors to each other using digital information and communication technology so as to act according to the collected information. Since this information may include behaviors of a supply company and a consumer, the smart grid may improve distribution of fuels such as electricity by a method having efficiency, reliability, economic feasibility, production sustainability, and automation. The smart grid may also be regarded as another sensor network having low latency.

Mission critical application (e.g., e-health) is one of 5G use scenarios. A health part contains many application programs capable of enjoying benefit of mobile communication. A communication system may support remote treatment that provides clinical treatment in a faraway place. Remote treatment may aid in reducing a barrier against distance and improve access to medical services that cannot be continuously available in a faraway rural area. Remote treatment is also used to perform important treatment and save lives in an emergency situation. The wireless sensor network based on mobile communication may provide remote monitoring and sensors for parameters such as heart rate and blood pressure.

Wireless and mobile communication gradually becomes important in the field of an industrial application. Wiring is high in installation and maintenance cost. Therefore, a possibility of replacing a cable with reconstructible wireless links is an attractive opportunity in many industrial fields. However, in order to achieve this replacement, it is necessary for wireless connection to be established with latency, reliability, and capacity similar to those of the cable and management of wireless connection needs to be simplified. Low latency and a very low error probability are new requirements when connection to 5G is needed.

Logistics and freight tracking are important use cases for mobile communication that enables inventory and package tracking anywhere using a location-based information system. The use cases of logistics and freight typically demand low data rate but require location information with a wide range and reliability.

Referring to FIG. 1, the communication system 1 includes wireless devices 100a to 100f, base stations (BSs) 200, and a network 300. Although FIG. 1 illustrates a 5G network as an example of the network of the communication system 1, the implementations of the present disclosure are not limited to the 5G system, and can be applied to the future communication system beyond the 5G system.

The BSs 200 and the network 300 may be implemented as wireless devices and a specific wireless device may operate as a BS/network node with respect to other wireless devices.

The wireless devices 100a to 100f represent devices performing communication using radio access technology (RAT) (e.g., 5G new RAT (NR)) or LTE) and may be referred to as communication/radio/5G devices. The wireless devices 100a to 100f may include, without being limited to, a robot 100a, vehicles 100b-1 and 100b-2, an extended reality (XR) device 100c, a hand-held device 100d, a home appliance 100e, an IoT device 100f, and an artificial intelligence (AI) device/server 400. For example, the vehicles may include a vehicle having a wireless communication function, an autonomous driving vehicle, and a vehicle capable of performing communication between vehicles. The vehicles may include an unmanned aerial vehicle (UAV) (e.g., a drone). The XR device may include an AR/VR/Mixed Reality (MR) device and may be implemented in the form of a head-mounted device (HMD), a head-up display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter.

In the present disclosure, the wireless devices 100a to 100f may be called user equipments (UEs). A UE may include, for example, a cellular phone, a smartphone, a laptop computer, a digital broadcast terminal, a personal digital assistant (PDA), a portable multimedia player (PMP), a navigation system, a slate personal computer (PC), a tablet PC, an ultrabook, a vehicle, a vehicle having an autonomous traveling function, a connected car, an UAV, an AI module, a robot, an AR device, a VR device, an MR device, a hologram device, a public safety device, an MTC device, an IoT device, a medical device, a FinTech device (or a financial device), a security device, a weather/environment device, a device related to a 5G service, or a device related to a fourth industrial revolution field.

The UAV may be, for example, an aircraft aviated by a wireless control signal without a human being onboard.

The VR device may include, for example, a device for implementing an object or a background of the virtual world. The AR device may include, for example, a device implemented by connecting an object or a background of the virtual world to an object or a background of the real world. The MR device may include, for example, a device implemented by merging an object or a background of the virtual world into an object or a background of the real world. The hologram device may include, for example, a device for implementing a stereoscopic image of 360 degrees by recording and reproducing stereoscopic information, using an interference phenomenon of light generated when two laser lights called holography meet.

The public safety device may include, for example, an image relay device or an image device that is wearable on the body of a user.

The MTC device and the IoT device may be, for example, devices that do not require direct human intervention or manipulation. For example, the MTC device and the IoT device may include smartmeters, vending machines, thermometers, smartbulbs, door locks, or various sensors.

The medical device may be, for example, a device used for the purpose of diagnosing, treating, relieving, curing, or preventing disease. For example, the medical device may be a device used for the purpose of diagnosing, treating, relieving, or correcting injury or impairment. For example, the medical device may be a device used for the purpose of inspecting, replacing, or modifying a structure or a function. For example, the medical device may be a device used for the purpose of adjusting pregnancy. For example, the medical device may include a device for treatment, a device for operation, a device for (in vitro) diagnosis, a hearing aid, or a device for procedure.

The security device may be, for example, a device installed to prevent a danger that may arise and to maintain safety. For example, the security device may be a camera, a closed-circuit TV (CCTV), a recorder, or a black box.

The FinTech device may be, for example, a device capable of providing a financial service such as mobile payment. For example, the FinTech device may include a payment device or a point of sales (POS) system.

The weather/environment device may include, for example, a device for monitoring or predicting a weather/environment.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, a 5G (e.g., NR) network, and a beyond-5G network. Although the wireless devices 100a to 100f may communicate with each other through the BSs 200/network 300, the wireless devices 100a to 100f may perform direct communication (e.g., sidelink communication) with each other without passing through the BSs 200/network 300. For example, the vehicles 100b-1 and 100b-2 may perform direct communication (e.g., vehicle-to-vehicle (V2V)/vehicle-to-everything (V2X) communication). The IoT device (e.g., a sensor) may perform direct communication with other IoT devices (e.g., sensors) or other wireless devices 100a to 100f.

Wireless communication/connections 150a, 150b and 150c may be established between the wireless devices 100a to 100f and/or between wireless device 100a to 100f and BS 200 and/or between BSs 200. Herein, the wireless communication/connections may be established through various RATs (e.g., 5GNR) such as uplink/downlink communication 150a, sidelink communication (or device-to-device (D2D) communication) 150b, inter-base station communication 150c (e.g., relay, integrated access and backhaul (IAB)), etc. The wireless devices 100a to 100f and the BSs 200/the wireless devices 100a to 100f may transmit/receive radio signals to/from each other through the wireless communication/connections 150a, 150b and 150c. For example, the wireless communication/connections 150a, 150b and 150c may transmit/receive signals through various physical channels. To this end, at least a part of various configuration information configuring processes, various signal processing processes (e.g., channel encoding/decoding, modulation/demodulation, and resource mapping/de-mapping), and resource allocating processes, for transmitting/receiving radio signals, may be performed based on the various proposals of the present disclosure.

AI refers to the field of studying artificial intelligence or the methodology that can create it, and machine learning refers to the field of defining various problems addressed in the field of AI and the field of methodology to solve them. Machine learning is also defined as an algorithm that increases the performance of a task through steady experience on a task.

Robot means a machine that automatically processes or operates a given task by its own ability. In particular, robots with the ability to recognize the environment and make self-determination to perform actions can be called intelligent robots. Robots can be classified as industrial, medical, home, military, etc., depending on the purpose or area of use. The robot can perform a variety of physical operations, such as moving the robot joints with actuators or motors. The movable robot also includes wheels, brakes, propellers, etc., on the drive, allowing it to drive on the ground or fly in the air.

Autonomous driving means a technology that drives on its own, and autonomous vehicles mean vehicles that drive without user's control or with minimal user's control. For example, autonomous driving may include maintaining lanes in motion, automatically adjusting speed such as adaptive cruise control, automatic driving along a set route, and automatically setting a route when a destination is set. The vehicle covers vehicles equipped with internal combustion engines, hybrid vehicles equipped with internal combustion engines and electric motors, and electric vehicles equipped with electric motors, and may include trains, motorcycles, etc., as well as cars. Autonomous vehicles can be seen as robots with autonomous driving functions.

Extended reality is collectively referred to as VR, AR, and MR. VR technology provides objects and backgrounds of real world only through computer graphic (CG) images. AR technology provides a virtual CG image on top of a real object image. MR technology is a CG technology that combines and combines virtual objects into the real world. MR technology is similar to AR technology in that they show real and virtual objects together. However, there is a difference in that in AR technology, virtual objects are used as complementary forms to real objects, while in MR technology, virtual objects and real objects are used as equal personalities.

NR supports multiples numerologies (and/or multiple subcarrier spacings (SCS)) to support various 5G services. For example, if SCS is 15 kHz, wide area can be supported in traditional cellular bands, and if SCS is 30 kHz/60 kHz, dense-urban, lower latency, and wider carrier bandwidth can be supported. If SCS is 60 kHz or higher, bandwidths greater than 24.25 GHz can be supported to overcome phase noise.

The NR frequency band may be defined as two types of frequency range, i.e., FR1 and FR2. The numerical value of the frequency range may be changed. For example, the frequency ranges of the two types (FR1 and FR2) may be as shown in Table 1 below. For ease of explanation, in the frequency ranges used in the NR system, FR1 may mean “sub 6 GHz range”, FR2 may mean “above 6 GHz range,” and may be referred to as millimeter wave (mmW). FR2 may include FR 2-1 and FR 2-2 as shown in Examples of Table 1 and Table 2.

TABLE 1

| Frequency Range | | Corresponding | Subcarrier | |
|---|---|---|---|---|
| designation | | frequency range | Spacing | |
| FR1 | | 450 MHz-6000 MHz | 15, 30, 60 | kHz |
| FR2 | FR2-1 | 24250 MHz-52600 MHz | 60, 120, 240 | kHz |
| | FR2-2 | 57000 MHz-71000 MHz | 120, 480, 960 | kHz |

As mentioned above, the numerical value of the frequency range of the NR system may be changed. For example, FR1 may include a frequency band of 410 MHz to 7125 MHz as shown in Table 2 below. That is, FR1 may include a frequency band of 6 GHz (or 5850, 5900, 5925 MHz, etc.) or more. For example, a frequency band of 6 GHz (or 5850, 5900, 5925 MHz, etc.) or more included in FR1 may include an unlicensed band. Unlicensed bands may be used for a variety of purposes, for example for communication for vehicles (e.g., autonomous driving).

TABLE 2

| Frequency Range | | Corresponding | Subcarrier | |
|---|---|---|---|---|
| designation | | frequency range | Spacing | |
| FR1 | | 410 MHz-7125 MHz | 15, 30, 60 | kHz |
| FR2 | FR2-1 | 24250 MHz-52600 MHz | 60, 120, 240 | kHz |
| | FR2-2 | 57000 MHz-71000 MHz | 120, 480, 960 | kHz |

Here, the radio communication technologies implemented in the wireless devices in the present disclosure may include narrowband internet-of-things (NB-IoT) technology for low-power communication as well as LTE, NR and 6G. For example, NB-IoT technology may be an example of low power wide area network (LPWAN) technology, may be implemented in specifications such as LTE Cat NB1 and/or LTE Cat NB2, and may not be limited to the above-mentioned names. Additionally and/or alternatively, the radio communication technologies implemented in the wireless devices in the present disclosure may communicate based on LTE-M technology. For example, LTE-M technology may be an example of LPWAN technology and be called by various names such as enhanced machine type communication (eMTC). For example, LTE-M technology may be implemented in at least one of the various specifications, such as 1) LTE Cat 0, 2) LTE Cat M1, 3) LTE Cat M2, 4) LTE non-bandwidth limited (non-BL), 5) LTE-MTC, 6) LTE Machine Type Communication, and/or 7) LTE M, and may not be limited to the above-mentioned names. Additionally and/or alternatively, the radio communication technologies implemented in the wireless devices in the present disclosure may include at least one of ZigBee, Bluetooth, and/or LPWAN which take into account low-power communication, and may not be limited to the above-mentioned names. For example, ZigBee technology may generate personal area networks (PANs) associated with small/low-power digital communication based on various specifications such as IEEE 802.15.4 and may be called various names.

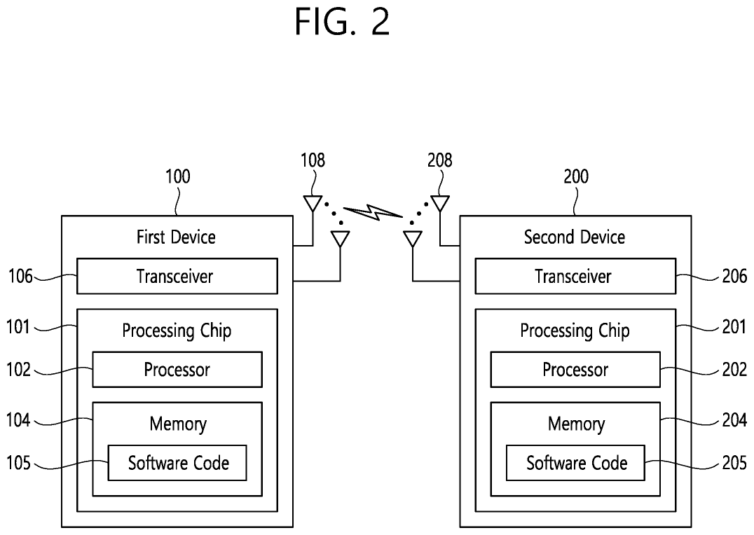

FIG. 2 shows an example of wireless devices to which implementations of the present disclosure is applied.

Referring to FIG. 2, a first wireless device 100 and a second wireless device 200 may transmit/receive radio signals to/from an external device through a variety of RATs (e.g., LTE and NR).

In FIG. 2, {the first wireless device 100 and the second wireless device 200} may correspond to at least one of {the wireless device 100a to 100f and the BS 200}, {the wireless device 100a to 100f and the wireless device 100a to 100f} and/or {the BS 200 and the BS 200} of FIG. 1.

The first wireless device 100 may include at least one transceiver, such as a transceiver 106, at least one processing chip, such as a processing chip 101, and/or one or more antennas 108.

The processing chip 101 may include at least one processor, such a processor 102, and at least one memory, such as a memory 104. It is exemplarily shown in FIG. 2 that the memory 104 is included in the processing chip 101. Additional and/or alternatively, the memory 104 may be placed outside of the processing chip 101.

The processor 102 may control the memory 104 and/or the transceiver 106 and may be configured to implement the descriptions, functions, procedures, suggestions, methods and/or operational flowcharts described in the present disclosure. For example, the processor 102 may process information within the memory 104 to generate first information/signals and then transmit radio signals including the first information/signals through the transceiver 106. The processor 102 may receive radio signals including second information/signals through the transceiver 106 and then store information obtained by processing the second information/signals in the memory 104.

The memory 104 may be operably connectable to the processor 102. The memory 104 may store various types of information and/or instructions. The memory 104 may store a software code 105 which implements instructions that, when executed by the processor 102, perform the descriptions, functions, procedures, suggestions, methods and/or operational flowcharts disclosed in the present disclosure. For example, the software code 105 may implement instructions that, when executed by the processor 102, perform the descriptions, functions, procedures, suggestions, methods and/or operational flowcharts disclosed in the present disclosure. For example, the software code 105 may control the processor 102 to perform one or more protocols. For example, the software code 105 may control the processor 102 to perform one or more layers of the radio interface protocol.

Herein, the processor 102 and the memory 104 may be a part of a communication modem/circuit/chip designed to implement RAT (e.g., LTE or NR). The transceiver 106 may be connected to the processor 102 and transmit and/or receive radio signals through one or more antennas 108. Each of the transceiver 106 may include a transmitter and/or a receiver. The transceiver 106 may be interchangeably used with radio frequency (RF) unit(s). In the present disclosure, the first wireless device 100 may represent a communication modem/circuit/chip.

The second wireless device 200 may include at least one transceiver, such as a transceiver 206, at least one processing chip, such as a processing chip 201, and/or one or more antennas 208.

The processing chip 201 may include at least one processor, such a processor 202, and at least one memory, such as a memory 204. It is exemplarily shown in FIG. 2 that the memory 204 is included in the processing chip 201. Additional and/or alternatively, the memory 204 may be placed outside of the processing chip 201.

The processor 202 may control the memory 204 and/or the transceiver 206 and may be configured to implement the descriptions, functions, procedures, suggestions, methods and/or operational flowcharts described in the present disclosure. For example, the processor 202 may process information within the memory 204 to generate third information/signals and then transmit radio signals including the third information/signals through the transceiver 206. The processor 202 may receive radio signals including fourth information/signals through the transceiver 106 and then store information obtained by processing the fourth information/signals in the memory 204.

The memory 204 may be operably connectable to the processor 202. The memory 204 may store various types of information and/or instructions. The memory 204 may store a software code 205 which implements instructions that, when executed by the processor 202, perform the descriptions, functions, procedures, suggestions, methods and/or operational flowcharts disclosed in the present disclosure. For example, the software code 205 may implement instructions that, when executed by the processor 202, perform the descriptions, functions, procedures, suggestions, methods and/or operational flowcharts disclosed in the present disclosure. For example, the software code 205 may control the processor 202 to perform one or more protocols. For example, the software code 205 may control the processor 202 to perform one or more layers of the radio interface protocol.

Herein, the processor 202 and the memory 204 may be a part of a communication modem/circuit/chip designed to implement RAT (e.g., LTE or NR). The transceiver 206 may be connected to the processor 202 and transmit and/or receive radio signals through one or more antennas 208. Each of the transceiver 206 may include a transmitter and/or a receiver. The transceiver 206 may be interchangeably used with RF unit. In the present disclosure, the second wireless device 200 may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as physical (PHY) layer, media access control (MAC) layer, radio link control (RLC) layer, packet data convergence protocol (PDCP) layer, radio resource control (RRC) layer, and service data adaptation protocol (SDAP) layer). The one or more processors 102 and 202 may generate one or more protocol data units (PDUs) and/or one or more service data unit (SDUs) according to the descriptions, functions, procedures, suggestions, methods and/or operational flowcharts disclosed in the present disclosure. The one or more processors 102 and 202 may generate messages, control information, data, or information according to the descriptions, functions, procedures, suggestions, methods and/or operational flowcharts disclosed in the present disclosure. The one or more processors 102 and 202 may generate signals (e.g., baseband signals) including PDUs, SDUs, messages, control information, data, or information according to the descriptions, functions, procedures, suggestions, methods and/or operational flowcharts disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, suggestions, methods and/or operational flowcharts disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202. The descriptions, functions, procedures, suggestions, methods and/or operational flowcharts disclosed in the present disclosure may be implemented using firmware or software and the firmware or software may be configured to include the modules, procedures, or functions. Firmware or software configured to perform the descriptions, functions, procedures, suggestions, methods and/or operational flowcharts disclosed in the present disclosure may be included in the one or more processors 102 and 202 or stored in the one or more memories 104 and 204 so as to be driven by the one or more processors 102 and 202. The descriptions, functions, procedures, suggestions, methods and/or operational flowcharts disclosed in the present disclosure may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the descriptions, functions, procedures, suggestions, methods and/or operational flowcharts disclosed in the present disclosure, to one or more other devices. The one or more transceivers 106 and 206 may receive user data, control information, and/or radio signals/channels, mentioned in the descriptions, functions, procedures, suggestions, methods and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices.

The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, suggestions, methods and/or operational flowcharts disclosed in the present disclosure, through the one or more antennas 108 and 208. In the present disclosure, the one or more antennas 108 and 208 may be a plurality of physical antennas or a plurality of logical antennas (e.g., antenna ports).

The one or more transceivers 106 and 206 may convert received user data, control information, radio signals/channels, etc., from RF band signals into baseband signals in order to process received user data, control information, radio signals/channels, etc., using the one or more processors 102 and 202. The one or more transceivers 106 and 206 may convert the user data, control information, radio signals/channels, etc., processed using the one or more processors 102 and 202 from the base band signals into the RF band signals. To this end, the one or more transceivers 106 and 206 may include (analog) oscillators and/or filters. For example, the one or more transceivers 106 and 206 can up-convert OFDM baseband signals to OFDM signals by their (analog) oscillators and/or filters under the control of the one or more processors 102 and 202 and transmit the up-converted OFDM signals at the carrier frequency. The one or more transceivers 106 and 206 may receive OFDM signals at a carrier frequency and down-convert the OFDM signals into OFDM baseband signals by their (analog) oscillators and/or filters under the control of the one or more processors 102 and 202.

In the implementations of the present disclosure, a UE may operate as a transmitting device in uplink (UL) and as a receiving device in downlink (DL). In the implementations of the present disclosure, a BS may operate as a receiving device in UL and as a transmitting device in DL. Hereinafter, for convenience of description, it is mainly assumed that the first wireless device 100 acts as the UE, and the second wireless device 200 acts as the BS. For example, the processor(s) 102 connected to, mounted on or launched in the first wireless device 100 may be configured to perform the UE behavior according to an implementation of the present disclosure or control the transceiver(s) 106 to perform the UE behavior according to an implementation of the present disclosure. The processor(s) 202 connected to, mounted on or launched in the second wireless device 200 may be configured to perform the BS behavior according to an implementation of the present disclosure or control the transceiver(s) 206 to perform the BS behavior according to an implementation of the present disclosure.

In the present disclosure, a BS is also referred to as a node B (NB), an eNode B (eNB), or a gNB.

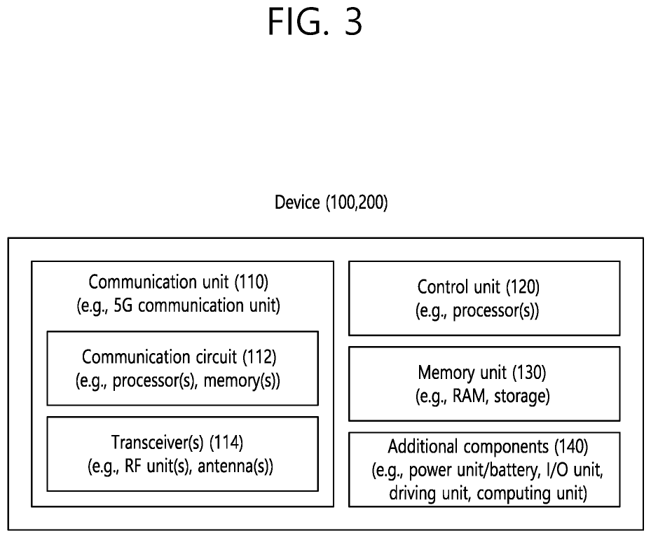

FIG. 3 shows an example of a wireless device to which implementations of the present disclosure is applied.

The wireless device may be implemented in various forms according to a use-case/service (refer to FIG. 1).

Referring to FIG. 3, wireless devices 100 and 200 may correspond to the wireless devices 100 and 200 of FIG. 2 and may be configured by various elements, components, units/portions, and/or modules. For example, each of the wireless devices 100 and 200 may include a communication unit 110, a control unit 120, a memory unit 130, and additional components 140. The communication unit 110 may include a communication circuit 112 and transceiver(s) 114. For example, the communication circuit 112 may include the one or more processors 102 and 202 of FIG. 2 and/or the one or more memories 104 and 204 of FIG. 2. For example, the transceiver(s) 114 may include the one or more transceivers 106 and 206 of FIG. 2 and/or the one or more antennas 108 and 208 of FIG. 2. The control unit 120 is electrically connected to the communication unit 110, the memory unit 130, and the additional components 140 and controls overall operation of each of the wireless devices 100 and 200. For example, the control unit 120 may control an electric/mechanical operation of each of the wireless devices 100 and 200 based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of the wireless devices 100 and 200. For example, the additional components 140 may include at least one of a power unit/battery, input/output (I/O) unit (e.g., audio I/O port, video I/O port), a driving unit, and a computing unit. The wireless devices 100 and 200 may be implemented in the form of, without being limited to, the robot (100a of FIG. 1), the vehicles (100b-1 and 100b-2 of FIG. 1), the XR device (100c of FIG. 1), the hand-held device (100d of FIG. 1), the home appliance (100e of FIG. 1), the IoT device (100f of FIG. 1), a digital broadcast terminal, a hologram device, a public safety device, an MTC device, a medicine device, a FinTech device (or a finance device), a security device, a climate/environment device, the AI server/device (400 of FIG. 1), the BSs (200 of FIG. 1), a network node, etc. The wireless devices 100 and 200 may be used in a mobile or fixed place according to a use-example/service.

In FIG. 3, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor (AP), an electronic control unit (ECU), a graphical processing unit, and a memory control processor. As another example, the memory unit 130 may be configured by a RAM, a DRAM, a ROM, a flash memory, a volatile memory, a non-volatile memory, and/or a combination thereof.

### <Operating Band in NR>

An operating band shown in Table 3 is a refraining operating band that is transitioned from an operating band of LTE/LTE-A. This operating band is referred to as FR1 band.

TABLE 3

| NR Operating | Uplink Operating Band | Downlink Operating Band | Duplex |
|---|---|---|---|
| Band | F_{UL}_{_{—}}_{low}-F_{UL}_{_{—}}_{high} | F_{DL}_{_{—}}_{low}-F_{DL}_{_{—}}_{high} | Mode |
| n1 | 1920 MHz-1980 MHz | 2110 MHz-2170 MHz | FDD |
| n2 | 1850 MHz-1910 MHz | 1930 MHz-1990 MHz | FDD |
| n3 | 1710 MHz-1785 MHz | 1805 MHz-1880 MHz | FDD |
| n5 | 824 MHz-849 MHz | 869 MHz-894 MHz | FDD |
| n7 | 2500 MHz-2570 MHz | 2620 MHz-2690 MHz | FDD |
| n8 | 880 MHz-915 MHz | 925 MHz-960 MHz | FDD |
| n12 | 699 MHz-716 MHz | 729 MHz-746 MHz | FDD |
| n14 | 788 MHz-798 MHz | 758 MHz-768 MHz | FDD |
| n18 | 815 MHz-830 MHz | 860 MHz-875 MHz | FDD |
| n20 | 832 MHz-862 MHz | 791 MHz-821 MHz | FDD |
| n25 | 1850 MHz-1915 MHz | 1930 MHz-1995 MHz | FDD |
| n26 | 814 MHz-849 MHz | 859 MHz-894 MHz | FDD |
| n28 | 703 MHz-748 MHz | 758 MHz-803 MHz | FDD |
| n29 | N/A | 717 MHz-728 MHz | SDL |
| n30 | 2305 MHz-2315 MHz | 2350 MHz-2360 MHz | FDD |
| n34 | 2010 MHz-2025 MHz | 2010 MHz-2025 MHz | TDD |
| n38 | 2570 MHz-2620 MHz | 2570 MHz-2620 MHz | TDD |
| n39 | 1880 MHz-1920 MHz | 1880 MHz-1920 MHz | TDD |
| n40 | 2300 MHz-2400 MHz | 2300 MHz-2400 MHz | TDD |
| n41 | 2496 MHz-2690 MHz | 2496 MHz-2690 MHz | TDD |
| n46 | 5150 MHz-5925 MHz | 5150 MHz-5925 MHz | TDD |
| n47 | 5855 MHz-5925 MHz | 5855 MHz-5925 MHz | TDD |
| n48 | 3550 MHz-3700 MHz | 3550 MHz-3700 MHz | TDD |
| n50 | 1432 MHz-1517 MHz | 1432 MHz-1517 MHz | TDD1 |
| n51 | 1427 MHz-1432 MHz | 1427 MHz-1432 MHz | TDD |
| n53 | 2483.5 MHz-2495 MHz | 2483.5 MHz-2495 MHz | TDD |
| n65 | 1920 MHz-2010 MHz | 2110 MHz-2200 MHz | FDD |
| n66 | 1710 MHz-1780 MHz | 2110 MHz-2200 MHz | FDD |
| n70 | 1695 MHz-1710 MHz | 1995 MHz-2020 MHz | FDD |
| n71 | 663 MHz-698 MHz | 617 MHz-652 MHz | FDD |
| n74 | 1427 MHz-1470 MHz | 1475 MHz-1518 MHz | FDD |
| n75 | N/A | 1432 MHz-1517 MHz | SDL |
| n76 | N/A | 1427 MHz-1432 MHz | SDL |
| n77 | 3300 MHz-4200 MHz | 3300 MHz-4200 MHz | TDD |
| n78 | 3300 MHz-3800 MHz | 3300 MHz-3800 MHz | TDD |
| n79 | 4400 MHz-5000 MHz | 4400 MHz-5000 MHz | TDD |
| n80 | 1710 MHz-1785 MHz | N/A | SUL |
| n81 | 880 MHz-915 MHz | N/A | SUL |
| n82 | 832 MHz-862 MHz | N/A | SUL |
| n83 | 703 MHz-748 MHz | N/A | SUL |
| n84 | 1920 MHz-1980 MHz | N/A | SUL |
| n86 | 1710 MHz-1780 MHz | N/A | SUL |
| n89 | 824 MHz-849 MHz | N/A | SUL |
| n90 | 2496 MHz-2690 MHz | 2496 MHz-2690 MHz | TDD |
| n91 | 832 MHz-862 MHz | 1427 MHz-1432 MHz | FDD |
| n92 | 832 MHz-862 MHz | 1432 MHz-1517 MHz | FDD |
| n93 | 880 MHz-915 MHz | 1427 MHz-1432 MHz | FDD |
| n94 | 880 MHz-915 MHz | 1432 MHz-1517 MHz | FDD |
| n95 | 2010 MHz-2025 MHz | N/A | SUL |
| n96 | 5925 MHz-7125 MHz | 5925 MHz-7125 MHz | TDD |

The following table shows an NR operating band defined at high frequencies. This operating band is referred to as FR2 band.

TABLE 4

| NR Operating | Uplink Operating Band | Downlink Operating Band | Duplex |
|---|---|---|---|
| Band | F_{UL}_{_{—}}_{low}-F_{UL}_{_{—}}_{high} | F_{DL}_{_{—}}_{low}-F_{DL}_{_{—}}_{high} | Mode |
| n257 | 26500 MHz-29500 MHz | 26500 MHz-29500 MHz | TDD |
| n258 | 24250 MHz-27500 MHz | 24250 MHz-27500 MHz | TDD |
| n259 | 39500 MHz-43500 MHz | 39500 MHz-43500 MHz | TDD |
| n260 | 37000 MHz-40000 MHz | 37000 MHz-40000 MHz | TDD |
| n261 | 27500 MHz-28350 MHz | 27500 MHz-28350 MHz | TDD |
| n262 | 47200 MHz-48200 MHz | 47200 MHz-48200 MHz | TDD |
| n263 | 57000 MHz-71000 MHz | 57000 MHz-71000 MHz | TDD |

<SS block in NR>

In the 5G NR, information required for a UE to perform an initial access, that is, a Physical Broadcast Channel (PBCH) including a Master Information Block (MIB) and a synchronization signal (SS) (including PSS and SSS) are defined as an SS block. In addition, a plurality of SS blocks may be grouped and defined as an SS burst, and a plurality of SS bursts may be grouped and defined as an SS burst set. It is assumed that each SS block is beamformed in a particular direction, and various SS blocks existing in an SS burst set are designed to support UEs existing in different directions.

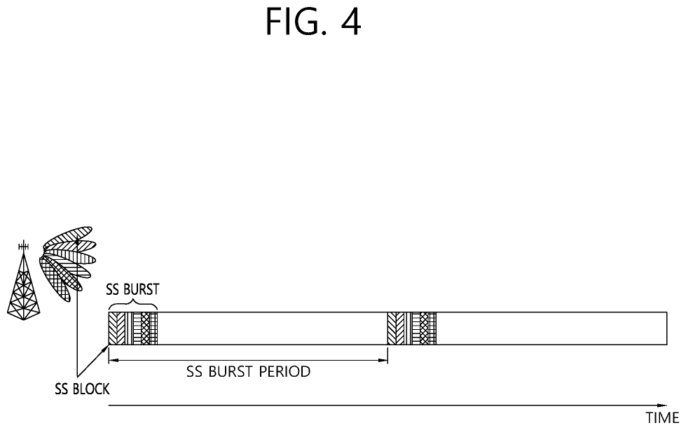

FIG. 4 is a diagram illustrating an example of an SS block in NR.

Referring to FIG. 4, an SS burst is transmitted in every predetermined periodicity. Accordingly, a UE receives SS blocks, and performs cell detection and measurement.

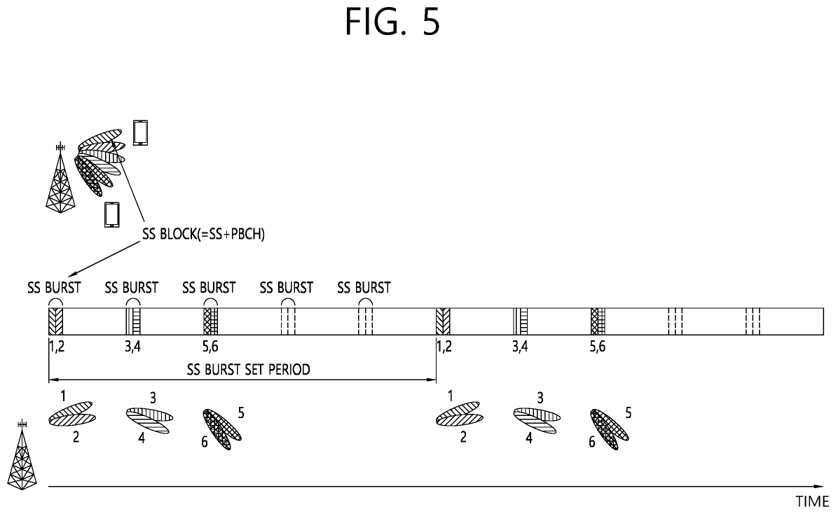

Meanwhile, in the 5G NR, beam sweeping is performed on an SS. A detailed description thereof will be provided with reference to FIG. 5.

FIG. 5 is a diagram illustrating an example of beam sweeping in the NR.

Abase station transmits each SS block in an SS burst overtime while performing beam sweeping. In this case, multiple SS blocks in an SS burst set are transmitted to support UEs existing in different directions. In FIG. 5, the SS burst set includes one to six SS blocks, and each SS burst includes two SS blocks.

### <Cell Search>

Cell search is the procedure by which a UE acquires time and frequency synchronization with a cell and detects the cell ID of that cell. NR cell search is based on the primary synchronization signal (PSS) and secondary synchronization signal (SSS), and PBCH demodulation reference signal (DM-RS), located on the synchronization raster.

The cell search procedure of the UE can be summarized in Table 5.

TABLE 5

| | Type of Signals | Operations |
|---|---|---|
| 1^{st} step | PSS | * SS/PBCH block (SSB) symbol timing |
| | | acquisition* Cell ID detection within a cell ID |
| | | group (3 hypothesis) |
| 2^{nd} Step | SSS | * Cell ID group detection (336 hypothesis) |
| 3^{rd} Step | PBCH DM-RS | * SSB index and Half frame index(Slot and frame |
| | | boundary detection) |
| 4^{th} Step | PBCH | * Time information (80 ms, SFN, SSB index, HF)* |
| | | RMSI CORESET/Search space configuration |
| 5^{th} Step | PDCCH and PDSCH | * Cell access information* RACH configuration |

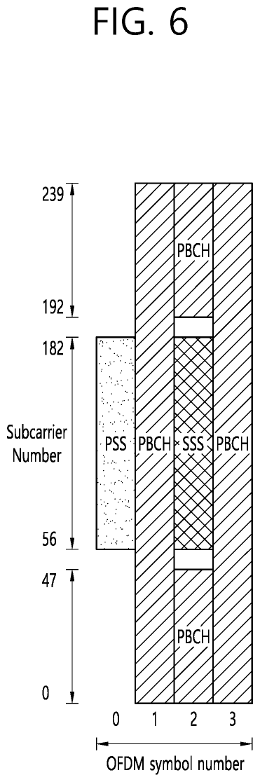

FIG. 6 shows an example of SSB to which implementations of the present disclosure can be applied.

The SSB consists of PSS and SSS, each occupying 1 symbol and 127 subcarriers, and PBCH spanning across 3 OFDM symbols and 240 subcarriers, but on one symbol leaving an unused part in the middle for SSS. The possible time locations of SSBs within a half-frame are determined by subcarrier spacing and the periodicity of the half-frames where SSBs are transmitted is configured by the network. During a half-frame, different SSBs may be transmitted in different spatial directions (i.e. using different beams, spanning the coverage area of a cell).

Within the frequency span of a carrier, multiple SSBs can be transmitted. The physical cell IDs (PCIs) of SSBs transmitted in different frequency locations do not have to be unique, i.e., different SSBs in the frequency domain can have different PCIs. However, when an SSB is associated with a remaining minimum system information (RMSI), the SSB corresponds to an individual cell, which has a unique NR cell global identity (NCGI). Such an SSB is referred to as a cell-defining SSB (CD-SSB). A PCell is always associated to a CD-SSB located on the synchronization raster.

Polar coding is used for PBCH.

The UE may assume a band-specific subcarrier spacing for the SSB unless a network has configured the UE to assume a different sub-carrier spacing.

PBCH symbols carry its own frequency-multiplexed DM-RS.

Quadrature phase shift keying (QPSK) modulation is used for PBCH.

System information (SI) consists of a master information block (MIB) and a number of system information blocks (SIBs), which are divided into minimum SI and other SI.

(1) Minimum SI comprises basic information required for initial access and information for acquiring any other SI. Minimum SI consists of
MIB contains cell barred status information and essential physical layer information of the cell required to receive further system information (e.g., SIB1), e.g. CORESET #0 configuration. MIB is always periodically broadcast on BCH with a periodicity of 80 ms and repetitions made within 80 ms. The first transmission of the MIB is scheduled in subframes as defined above for SS/PBCH block and repetitions are scheduled according to the period of SSB.
SIB1 defines the availability and the scheduling of other system information blocks (e.g., mapping of SIBs to SI message, periodicity, SI-window size) with an indication whether one or more SIBs are only provided on-demand and, in that case, the configuration needed by the UE to perform the SI request and contains information required for initial access. SIB1 is also referred to as RMSI and is periodically broadcast on DL-SCH or sent in a dedicated manner on DL-SCH to UEs in RRC_CONNECTED, with a periodicity of 160 ms and variable transmission repetition periodicity within 160 ms. The default transmission repetition periodicity of SIB1 is 20 ms but the actual transmission repetition periodicity is up to network implementation. For SSB and CORESET multiplexing pattern 1, SIB1 repetition transmission period is 20 ms. For SSB and CORESET multiplexing pattern 2/3, SIB1 transmission repetition period is the same as the SSB period. SIB1 is cell-specific SIB.

(2) Other SI encompasses all SIBs not broadcast in the minimum SI. Those SIBs can either be periodically broadcast on DL-SCH, broadcast on-demand on DL-SCH (i.e., upon request from UEs in RRC_IDLE or RRC_INACTIVE), or sent in a dedicated manner on DL-SCH to UEs in RRC_CONNECTED. SIBs in other SI are carried in SystemInformation (SI) messages. Only SIBs having the same periodicity can be mapped to the same SI message. Each SI message is transmitted within periodically occurring time domain windows (referred to as SI-windows with same length for all SI messages). Each SI message is associated with an SI-window and the SI-windows of different SI messages do not overlap. That is, within one SI-window only the corresponding SI message is transmitted. An SI message may be transmitted a number of times within the SI-window. Any SIB except SIB1 can be configured to be cell specific or area specific, using an indication in SIB1. The cell specific SIB is applicable only within a cell that provides the SIB while the area specific SIB is applicable within an area referred to as SI area, which consists of one or several cells and is identified by systeminformationAreaID. Other SI consists of:
SIB2 contains cell re-selection information, mainly related to the serving cell;
SIB3 contains information about the serving frequency and intra-frequency neighbouring cells relevant for cell re-selection (including cell re-selection parameters common for a frequency as well as cell specific re-selection parameters);
SIB4 contains information about other NR frequencies and inter-frequency neighbouring cells relevant for cell re-selection (including cell re-selection parameters common for a frequency as well as cell specific re-selection parameters);
SIB5 contains information about E-UTRA frequencies and E-UTRA neighbouring cells relevant for cell re-selection (including cell re-selection parameters common for a frequency as well as cell specific re-selection parameters);
SIB6 contains an earthquake and tsunami warning system (ETWS) primary notification;
SIB7 contains an ETWS secondary notification;
SIB8 contains a commercial mobile alert system (CMAS) warning notification;
SIB9 contains information related to global positioning system (GPS) time and coordinated universal Time (UTC).

For a UE in RRC_CONNECTED, the network can provide system information through dedicated signaling using the RRCReconfiguration message, e.g. if the UE has an active BWP with no common search space configured to monitor system information or paging.

For PSCell and SCells, the network provides the required SI by dedicated signaling, i.e., within an RRCReconfiguration message. Nevertheless, the UE shall acquire MIB of the PSCell to get system frame number (SFN) timing of the SCG (which may be different from MCG). Upon change of relevant SI for SCell, the network releases and adds the concerned SCell. For PSCell, the required SI can only be changed with Reconfiguration with Sync.

The physical layer imposes a limit to the maximum size a SIB can take. The maximum SIB1 or SI message size is 2976 bits.

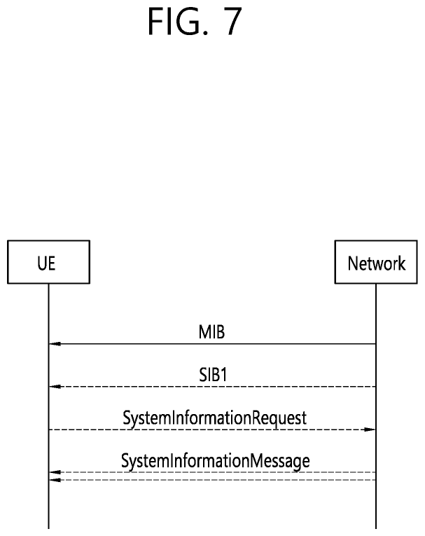

FIG. 7 shows an example of SI acquisition procedure to which implementations of the present disclosure can be applied.

The UE applies the SI acquisition procedure to acquire the AS and NAS information. The procedure applies to UEs in RRC_IDLE, in RRC_INACTIVE and in RRC_CONNECTED.

The UE in RRC_IDLE and RRC_INACTIVE shall ensure having a valid version of (at least) the MIB, SIB1 through SIB4 and SIB5 (if the UE supports E-UTRA).

For a cell/frequency that is considered for camping by the UE, the UE is not required to acquire the contents of the minimum SI of that cell/frequency from another cell/frequency layer. This does not preclude the case that the UE applies stored SI from previously visited cell(s).

If the UE cannot determine the full contents of the minimum SI of a cell by receiving from that cell, the UE shall consider that cell as barred.

In case of bandwidth adaptation (BA), the UE only acquires SI on the active BWP.

For UEs in RRC_IDLE and RRC_INACTIVE, a request for other SI triggers a random access procedure where MSG3 includes the SI request message unless the requested SI is associated to a subset of the PRACH resources, in which case MSG1 is used for indication of the requested other SI. When MSG1 is used, the minimum granularity of the request is one SI message (i.e., a set of SIBs), one RACH preamble and/or PRACH resource can be used to request multiple SI messages and the gNB acknowledges the request in MSG2. When MSG 3 is used, the gNB acknowledges the request in MSG4.

The other SI may be broadcast at a configurable periodicity and for a certain duration. The other SI may also be broadcast when it is requested by UE in RRC_IDLE/RRC_INACTIVE.

For a UE to be allowed to camp on a cell it must have acquired the contents of the minimum SI from that cell. There may be cells in the system that do not broadcast the minimum SI and where the UE therefore cannot camp.

Change of system information (other than for ETWS/CMAS4) only occurs at specific radio frames, i.e., the concept of a modification period is used. System information may be transmitted a number of times with the same content within a modification period, as defined by its scheduling. The modification period is configured by system information.

When the network changes (some of the) system information, it first notifies the UEs about this change, i.e., this may be done throughout a modification period. In the next modification period, the network transmits the updated system information. Upon receiving a change notification, the UE acquires the new system information from the start of the next modification period. The UE applies the previously acquired system information until the UE acquires the new system information.

The random access procedure of the UE can be summarized in Table 6.

TABLE 6

| | Type of Signals | Operations/Information Acquired |
|---|---|---|
| 1^{st} step | PRACH preamble in UL | * Initial beam acquisition* Random election |
| | | of RA-preamble ID |
| 2^{nd} Step | Random Access | * Timing alignment information* RA- |
| | Response on DL-SCH | preamble ID |
| | | * Initial UL grant, Temporary C-RNTI |
| 3^{rd} Step | UL transmission on UL- | * RRC connection request* UE identifier |
| | SCH | |
| 4^{th} Step | Contention Resolution | * Temporary C-RNTI on PDCCH for initial |
| | on DL | access* C-RNTI on PDCCH for UE in |
| | | RRC_CONNECTED |

The random access procedure is triggered by a number of events:
Initial access from RRC_IDLE;
RRC connection re-establishment procedure;
DL or UL data arrival during RRC_CONNECTED when UL synchronization status is “non-synchronized”;
UL data arrival during RRC_CONNECTED when there are no PUCCH resources for scheduling request (SR) available;
SR failure;
Request by RRC upon synchronous reconfiguration (e.g., handover);
Transition from RRC_INACTIVE;
To establish time alignment for a secondary timing advance group (TAG);
Request for other SI;
Beam failure recovery.

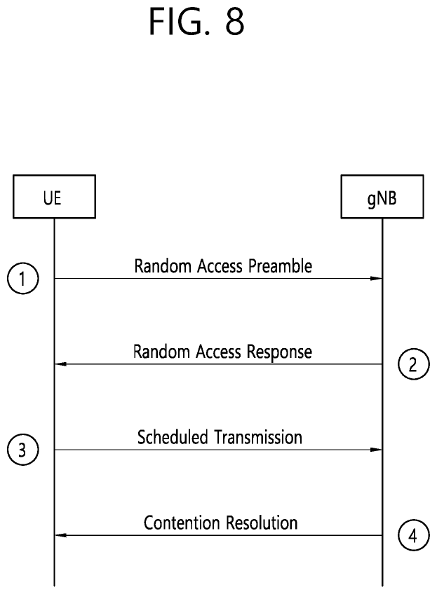

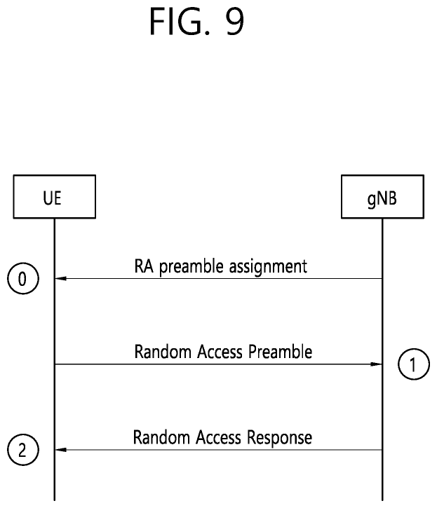

FIG. 8 shows an example of contention-based random access (CBRA) to which implementations of the present disclosure can be applied. FIG. 9 shows an example of contention-free random access (CFRA) to which implementations of the present disclosure can be applied.

For random access in a cell configured with supplementary UL (SUL), the network can explicitly signal which carrier to use (UL or SUL). Otherwise, the UE selects the SUL carrier if and only if the measured quality of the DL is lower than a broadcast threshold. Once started, all uplink transmissions of the random access procedure remain on the selected carrier.

When CA is configured, the first three steps of CBRA always occur on the PCell while contention resolution (step 4) can be cross-scheduled by the PCell. The three steps of a CFRA started on the PCell remain on the PCell. CFRA on SCell can only be initiated by the gNB to establish timing advance for a secondary TAG: the procedure is initiated by the gNB with a PDCCH order (step 0) that is sent on a scheduling cell of an activated SCell of the secondary TAG, preamble transmission (step 1) takes place on the indicated SCell, and random access response (step 2) takes place on PCell.

Random access preamble sequences, of two different lengths are supported. Long sequence length 839 is applied with subcarrier spacings of 1.25 and 5 kHz and short sequence length 139 is applied with subcarrier spacings of 15, 30, 60 and 120 kHz. Long sequences support unrestricted sets and restricted sets of Type A and Type B, while short sequences support unrestricted sets only.

Multiple PRACH preamble formats are defined with one or more PRACH OFDM symbols, and different cyclic prefix and guard time. The PRACH preamble configuration to use is provided to the UE in the system information.

The UE calculates the PRACH transmit power for the retransmission of the preamble based on the most recent estimate pathloss and power ramping counter.

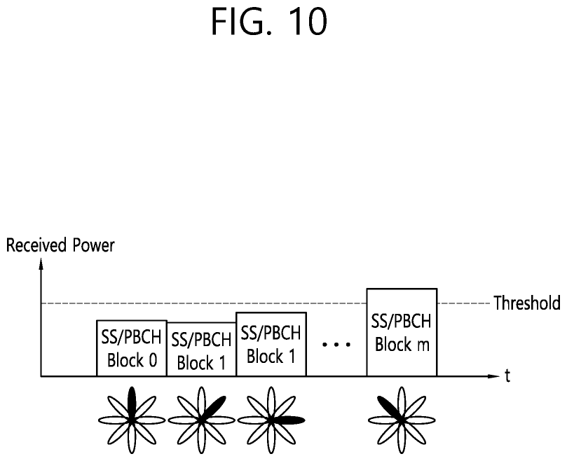

FIG. 10 shows a concept of threshold of the SSB for RACH resource association to which implementations of the present disclosure can be applied.

The system information provides information for the UE to determine the association between the SSB and the RACH resources. The reference signal received power (RSRP) threshold for SSB selection for RACH resource association is configurable by network.

### <Disclosure of the Present Specification>

NR operating bands in Frequency Range (FR) 2 was introduced. Among NR operating bands in FR 2, operating band n263 was newly introduced. However, in prior art, channel raster for n263 band was not defined.

For example, basic concept of channel raster based on 60 kHz separation between two adjacent raster locations was merely defined.

This dense raster leads to very high number or channel raster locations that UE needs to support. This very high number or channel raster locations creates problems, such as unnecessary overhead of the UE, especially on FR 2-2 frequency range, in which the n263 band included, where wide channel band widths are used on 14 GHz wide operating band.

Therefore, channel raster, New Radio Absolute Radio Frequency Channel Number (NR-ARFCN) for operating band n263 needs to be defined.

Disclosure of the present specification may describe examples of Channel raster definition for NR radio operating in 60 GHz frequency range (FR2-2).

Channel raster and synchronization (SSB) raster for NR operating bands related to 52.6-71 GHz frequency band work item are being discussed. Currently prior arts merely define generic channel and synchronization raster for NR FR2 operation.

Channel Raster is Explained as Follows:

### NR Absolute Radio Frequency Channel Number (NR-ARFCN).

The global frequency raster defines a set of Radio Frequency (RF) reference frequencies F_{REF}. The RF reference frequency is used in signaling to identify the position of RF channels, SS blocks and other elements. For example, UE may identify the position of RF channels, SS blocs, and other elements based on global frequency raster. For example, the UE may identify channel for performing communication based on channel raster.

The global frequency raster is defined for all frequencies from 0 to 100 GHz. The granularity of the global frequency raster may be ΔF_{Global}.

RF reference frequency is designated by an NR Absolute Radio Frequency Channel Number (NR-ARFCN) in the range [2016667 . . . 3279165] on the global frequency raster. The relation between the NR-ARFCN and the RF reference frequency F_{REF} in MHz is given by the following equation: F_{REF}=F_{REF-Offs}+ΔF_{Global} (N_{REF}−N_{REF-Offs}). Where F_{REF-Offs} and N_{Ref-Offs} are given in table 7 and N_{REF} may be the NR-ARFCN.

TABLE 7

| Frequency range | ΔF_{Global} | F_{REF-Offs} | | |
|---|---|---|---|---|
| (MHz) | (kHz) | [MHz] | N_{REF-Offs} | Range of N_{REF} |
| 24250-100000 | 60 | 24250.08 | 2016667 | 2016667-3279165 |

Table 7 shows examples of NR-ARFCN parameters for the global frequency raster.

N_{REF} may mean NR-ARFCN. N_{REF}-Offs may mean offset used for calculating N_{REF}. ΔF_{Global} may mean Granulraity of the global frequency raster. F_{REF-Offs} may mean offset used for calculating F_{REF}.

The following drawings are prepared to explain a specific example of the present specification. Since the names of specific devices or names of specific signals/messages/fields described in the drawings are provided by way of example, technical features of the present specification are not limited to specific names used in the following drawings.

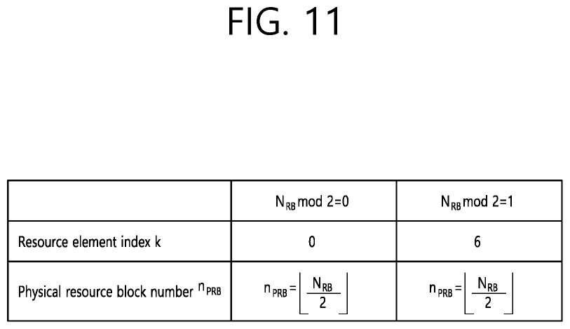

FIG. 11 illustrates an example of channel raster to resource element mapping.

The mapping between the RF reference frequency on channel raster and the corresponding resource element is given in FIG. 11. The mapping can be used to identify the RF channel position. The mapping depends on the total number of Resource Blocks (RBs) that are allocated in the channel and applies to both UL and DL. The mapping must apply to at least one numerology supported by the UE.

As shown in FIG. 11, k may be used as resource elements index. n_{PRB} may be used as physical resource block number. “mod” may mean mod function.

Channel raster entries for each operating band may be defined as follows.

The RF channel positions on the channel raster in each NR operating band are given through the applicable NR-ARFCN in Table 8, using the channel raster to resource element mapping.

TABLE 8

| | | Uplink and Downlink |
|---|---|---|
| Operating | ΔF_{Raster} | Range of N_{REF} |
| Band | (kHz) | (First-<Step size>-Last) |
| n257 | 60 | 2054166-<1>-2104165 |
| | 120 | 2054167-<2>-2104165 |
| n258 | 60 | 2016667-<1>-2070832 |
| | 120 | 2016667-<2>-2070831 |
| n260 | 60 | 2229166-<1>-2279165 |
| | 120 | 2229167-<2>-2279165 |
| n261 | 60 | 2070833-<1>-2084999 |
| | 120 | 2070833-<2>-2084999 |

Table 8 shows example of Applicable NR-ARFCN per operating band.
For NR operating bands with 60 kHz channel raster above 24 GHz, ΔF_{Raster}=I XΔF_{Global}, where I {1,2}. Every I^{th} NR-ARFCN within the operating band are applicable for the channel raster within the operating band and the step size for the channel raster in table 8 is given as <I>.
In frequency bands with two ΔF_{Raster}, the higher ΔF_{Raster} applies to channels using only the SCS that equals the higher ΔF_{Raster}.

For example, for band n260 with 120 kHz SCS the channel raster may utilize only every 2^{nd} option from general 60 kHz raster. The first RF channel position on the channel raster may be 2054.166 MHz. The second RF channel position on the channel raster may be 2054.166 MHz+2*60 kHz=2054.286 MHz.

As shown in the table 8, the step size and number of the possible ARFCN depends on the ΔF_{Raster}, which is same as SCS that equals the higher ΔF_{Raster}.

The operation on 60 GHz frequency range between 52.6 and 71 GHz and also called as RF2-2 is planned to be based on operating channel bandwidth between 100 MHz and 2000 MHz and SCS of 120, 480 and 960 kHz.

Definition of frequency ranges may be same as the example of Table 2, which has been already explained.

Whenever the FR2 is referred, both FR2-1 and FR2-2 frequency sub-ranges shall be considered, unless otherwise stated.

The list of supported bands is not known yet. But work has started on defining the channel raster for frequency range between the 57 and 71 GHz, which aligns with band that is fully or partly designated for un-licensed operations in most International Telecommunication Union (ITU) regions.

NR operating band in FR2 may be based on examples of Table 4. NR operating band nXXX may be the same as operating band n263

Synchronization Raster is Explained as Follows:

Hereinafter, synchronization raster and numbering are explained.

The synchronization raster indicates the frequency positions of the synchronization block that can be used by the UE for system acquisition when explicit signaling of the synchronization block position is not present.

A global synchronization raster is defined for all frequencies. The frequency position of the SS block is defined as SS_{REF} with corresponding number GSCN(Global Synchronization Raster Channel). The parameters defining the SS_{REF} and GSCN for all the frequency ranges are in Table 9.

The resource element corresponding to the SS block reference frequency SS_{REF} is given in subclause 5.4.3.2. of 3GPP TS 38.213 V16.4.0. The synchronization raster and the subcarrier spacing of the synchronization block is defined separately for each band.

TABLE 9

| Frequency | SS block frequency | | Range of |
|---|---|---|---|
| range | position SS_{REF} | GSCN | GSCN |
| 24250-100000 | 24250.08 MHz + N * 17.28 | 22256 + N | 22256-26639 |
| MHz | MHz, N = 0:4383 | | |

Table 9 shows examples of GSCN parameters for the global frequency raster.

### 1. First Example of the Present Disclosure

When defining the NR-ARFCN raster for this band following points need to be considered. For reference, NR-ARFCN raster may be same as channel raster.:
There is 14 GHz of contiguous spectrum and hence it is natural to target operation with wide bandwidth channels, like 2 GHz, while also enabling the narrower bandwidth transmission, like 100 MHz, to boost the coverage.
In order to support the widest bandwidths, it is necessary to support also the largest SCS and therefore the ARFCN raster should be selected in a way that ARFCN raster and SCS raster for 960 kHz SCS are aligned.
In order to support co-existence with other wide band systems like operating bands in Wi-Fi standards (e.g. 802.11ad and 802.11ay) the ARFCN should enable the positioning of the NR channels in a way that NR-channel does not overlap with two 802.11ad channels or 802.11ay channels.
In order to minimize the system complexity the number of potential ARFCN entries should be minimized.

In order to address the targets above following proposal may be made:
1) Define ARFCN in a way that there is a raster location with 50 MHz steps between 57,050 MHz and 70 950 MHz.
2) Select the ARFCN raster in a way that starting frequency is as close to 57,050 MHz as possible and delta between the ARFCN raster locations may always be a multiple of 960 kHz i.e. delta between N_{REF} is multiple of 16 (16×60 kHz=960 kHz).

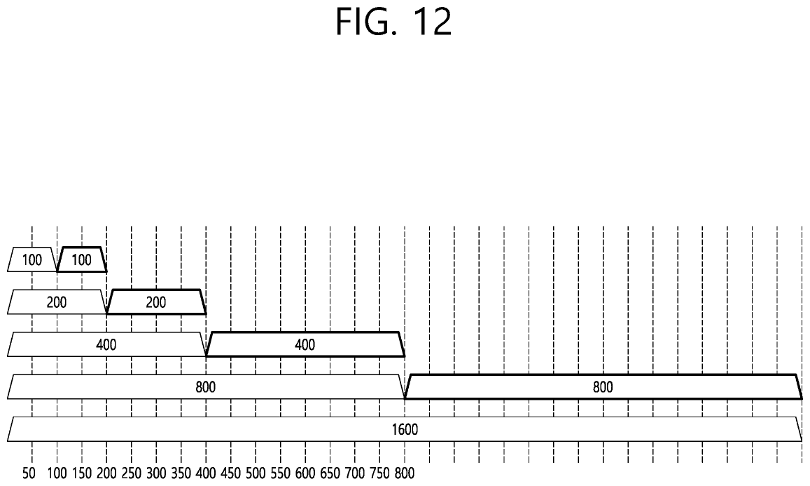

50 MHz granularity for the ARFCN is selected to support multiple channel bandwidths with most narrow one being 100 MHz as shown in FIG. 12.

The following drawings are prepared to explain a specific example of the present specification. Since the names of specific devices or names of specific signals/messages/fields described in the drawings are provided by way of example, technical features of the present specification are not limited to specific names used in the following drawings.

FIG. 12 illustrates an example of 50 MHz raster to support channel bandwidth according to the present disclosure.

FIG. 12 shows example of 50 MHz raster to support 100 MHz minimum channel bandwidth.

For example, according to an example of FIG. 12, 200 MHz channel can be placed in a way that it covers two 100 MHz channels, 400 MHz channel to cover two 200 MHz channels and so on.

For example, according to FIG. 12, raster (e.g. channel raster) with 50 MHz based on dotted lines are shown.

Examples of NR-ARFCN for operating band nXXX(e.g. n263) according to the first example of the present disclosure may be proposed as an example of Table 10.

TABLE 10

| | | Uplink and Downlink |
|---|---|---|
| | ΔF_{Raster} | Range of N_{REF} |
| Operating Band | (kHz) | (First-<Step size>-Last) |
| n257 | 60 | 2054166-<1>-2104165 |
| | 120 | 2054167-<2>-2104165 |
| n258 | 60 | 2016667-<1>-2070832 |
| | 120 | 2016667-<2>-2070831 |
| n260 | 60 | 2229166-<1>-2279165 |
| | 120 | 2229167-<2>-2279165 |
| n261 | 60 | 2070833-<1>-2084999 |
| | 120 | 2070833-<2>-2084999 |
| nXXX | 120, 480, 960 | 2563333-<NOTE1>-2794997 |

NOTE1:
Step size vector with length of 12: <832 832 832 832 832 832 848 832 832 832 832 832>

Table 10 shows an example of applicable NR-ARFCN per operating band.

nXXX of Table 10 may be operating band n263. Step size for operating band nXXX may be based on Step size vector with length of 12: <832 832 832 832 832 832 848 832 832 832 832 832>. For example, when 120 kHz SCS is configured, first N_{REF} for nXXX may be 2563.333 MHz. Second N_{REF} for nXXX may be 2563.333 MHz+832*60 kHz=2613.253 MHz.

With the proposed arrangement the delta between the 50 MHz ideal raster and the ARFCN raster defined frequencies varies between −440 kHz and 440 kHz. The step size of 832 equals to 832*65 kHz=49.92 MHz and 848 equals to 848*60 kHz=50.88 MH. For example, the step size vector 832 832 832 832 832 832 848 832 832 832 832 832> corresponds to frequency steps of 11*49.92 MHz+1*50.88 MHz, which adds up to 600 MHz. The center frequency for the lowest ARFCN is 57 050.04 MHz and center frequency for highest one is 70 949.88 MHz. The number of ARFCN entries is 279.

The applicability of the proposal for supporting the co-existence with Wi-Fi channels, such as 802.11ad and 802.11ay channels, with channel center frequencies in Table 11 is analyzed as below.

TABLE 11

| | | | | | Channel | |
|---|---|---|---|---|---|---|
| | Channel | Flow | Fcenter | Fhigh | BW | Unit |
| 802.11ad | #1 | 57 240 | 58 320 | 59 400 | 2 160 | MHz |
| | #2 | 59 400 | 60 480 | 61 560 | 2 160 | MHz |
| | #3 | 61 560 | 62 640 | 63 720 | 2 160 | MHz |
| | #4 | 63 720 | 64 800 | 65 880 | 2 160 | MHz |
| | #5 | 65 880 | 66 960 | 68 040 | 2 160 | MHz |
| | #6 | 68 040 | 69 120 | 70 200 | 2 160 | MHz |
| 802.11ay | #9 | 57 240 | 59 400 | 61 560 | 4 320 | MHz |
| | #10 | 59 400 | 61 560 | 63 720 | 4 320 | MHz |
| | #11 | 61 560 | 63 720 | 65 880 | 4 320 | MHz |
| | #12 | 63 720 | 65 880 | 68 040 | 4 320 | MHz |
| | #13 | 65 880 | 68 040 | 70 200 | 4 320 | MHz |

According to Table 11, Flow may mean lowest frequency of the corresponding channel. Fcenter may mean center frequency of the corresponding channel. Fhigh may mean highest frequency of the corresponding channel.

TABLE 12

| | | Fcenter | | NR | | |
|---|---|---|---|---|---|---|
| | Channel | 802 | Fcenter NR | ARFCN | Delta | Unit |
| 802.11ad | #1 | 58 320 | 58 299,96 | 2 584 165 | −20.04 | MHz |
| | #2 | 60 480 | 60 500,28 | 2 620 837 | 20.28 | MHz |
| | #3 | 62 640 | 62 649,72 | 2 656 661 | 9.72 | MHz |
| | #4 | 64 800 | 64 800,12 | 2 692 501 | 0.12 | MHz |
| | #5 | 66 960 | 66 949,56 | 2 728 325 | −10.44 | MHz |
| | #6 | 69 120 | 69 099,96 | 2 764 165 | −20.04 | MHz |
| 802.11ay | #9 | 59 400 | 59 400,12 | 2 602 501 | 0.12 | MHz |
| | #10 | 61 560 | 61 549,56 | 2 638 325 | −10.44 | MHz |
| | #11 | 63 720 | 63 699,96 | 2 674 165 | −20.04 | MHz |
| | #12 | 65 880 | 65 900,28 | 2 710 837 | 20.28 | MHz |
| | #13 | 68 040 | 68 049,72 | 2 746 661 | 9.72 | MHz |

Table 12 shows examples of Channel center frequency delta between the 802.11 system and NR.

The frequency delta between the channel center frequencies of 802.11ad and 802.11ay and closest ARFCN following the proposal above with Table 12 is shown in Table 12.

As can be seen the delta between these two varies between ˜20.04 and +20.28 MHz in case of 802.11ad, which means that it is possible to place up to
21×100 MHz
5×400 MHz
1×2000 MHz
wide NR channels and various combinations of these adding up to 2100 MHz width within the 2160 MHz wide 802.11ad channel using the proposed set of ARFCN, Therefore there is no need to define additional ARFCN to avoid cases where NR channel would overlap with two 802.11ad channels.

Similarly, in the case of 802.11ay it is possible to place up to
42×100 MHz
10×400 MHz
2×2000 MHz
wide NR channels and various combinations of these adding up to 4200 MHz width within the 4320 MHz wide 802.11ay channel using the proposed set of ARFCN. Therefore there is no need to define additional ARFCN to avoid cases where NR channel would overlap with two 802.11ay channels.

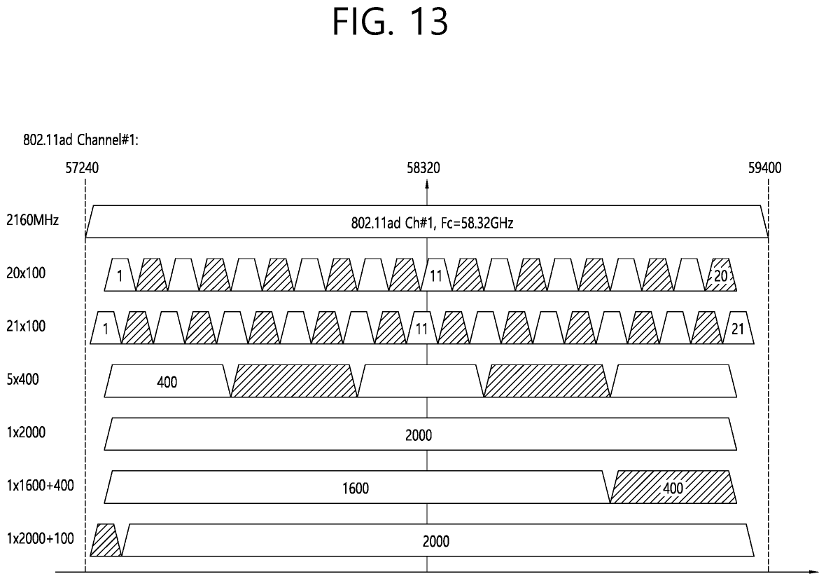

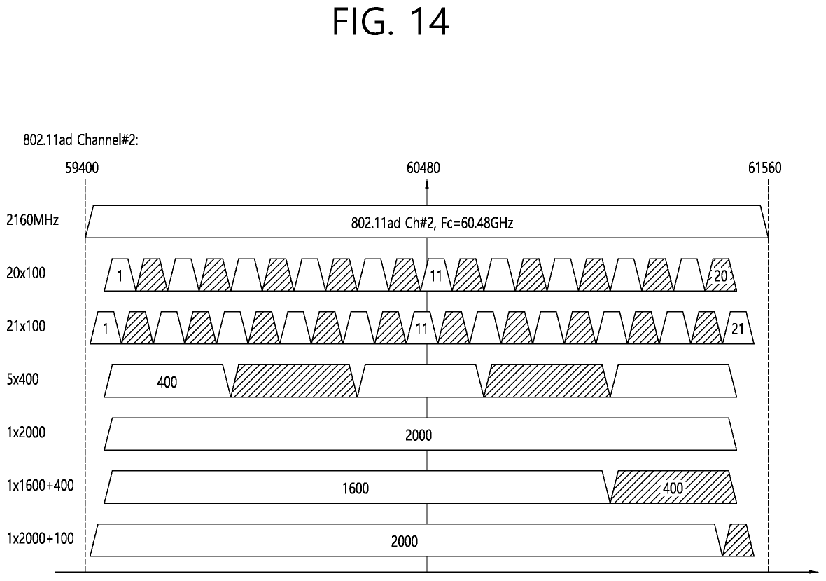

Examples for these co-existence configurations in the case of 802.11ad channels #1 and #2 are also illustrated in the FIG. 13 and FIG. 14. Examples of FIG. 13 and FIG. 14 shows example of Alignment of NR and 802.11ad channels.

The following drawings are prepared to explain a specific example of the present specification. Since the names of specific devices or names of specific signals/messages/fields described in the drawings are provided by way of example, technical features of the present specification are not limited to specific names used in the following drawings.

FIG. 13 illustrates an example of co-existence configuration case with 802.11ad channel #1. according to the present disclosure.

According to FIG. 13, based on 802.11ad channel #1 having channel bandwidth of 2160 MHz. There are 6 examples of co-existence configuration case for configuring NR channel within frequency range of 802.11ad channel #1.

The following drawings are prepared to explain a specific example of the present specification. Since the names of specific devices or names of specific signals/messages/fields described in the drawings are provided by way of example, technical features of the present specification are not limited to specific names used in the following drawings.

FIG. 14 illustrates an example of co-existence configuration case with 802.11ad channel #2. according to the present disclosure.

According to FIG. 14, based on 802.11ad channel #2 having channel bandwidth of 2160 MHz. There are 6 examples of co-existence configuration case for configuring NR channel within frequency range of 802.11ad channel #2.

The proposed ARFCN definition scheme can also be extended to cover the whole band from 52 600 to 71 000 MHz in case that new bands are added. Examples for those are provided below as bands nYYY and nZZZ. In order to minimize the error between the targeted channel center frequency and the entry in 49.92/50.88 MHz ARFCN raster, the value of the First entry may need to be adjusted and following that also the step size vector may need to be adjusted by shifting the location of the 848(e.g. step size 848) left or right in order to keep the maximum center frequency delta between −440 and +440 kHz. 12 different step size vector options are listed below:
1)<848 832 832 832 832 832 832 832 832 832 832 832>
2)<832 848 832 832 832 832 832 832 832 832 832 832>
3)<832 832 848 832 832 832 832 832 832 832 832 832>
4)<832 832 832 848 832 832 832 832 832 832 832 832>
5)<832 832 832 832 848 832 832 832 832 832 832 832>
6)<832 832 832 832 832 848 832 832 832 832 832 832>
7)<832 832 832 832 832 832 848 832 832 832 832 832>
8)<832 832 832 832 832 832 832 848 832 832 832 832>
9)<832 832 832 832 832 832 832 832 848 832 832 832>
10)<832 832 832 832 832 832 832 832 832 848 832 832>
11)<832 832 832 832 832 832 832 832 832 832 848 832>
12)<832 832 832 832 832 832 832 832 832 832 832 848>

Considering nYYY band and nZZZ band in addition to nXXX band, Table 13 is shown.

TABLE 13

| | Uplink Operating | Downlink Operating | |
|---|---|---|---|
| NR | Band | Band | |
| Operating | F_{UL}_{_{—}}_{low}- | F_{DL}_{_{—}}_{low}- | Duplex |
| Band | F_{UL}_{_{—}}_{high} | F_{DL}_{_{—}}_{high} | Mode |
| n257 | 26500 MHz-29500 MHz | 26500 MHz-29500 MHz | TDD |
| n258 | 24250 MHz-27500 MHz | 24250 MHz-27500 MHz | TDD |
| n260 | 37000 MHz-40000 MHz | 37000 MHz-40000 MHz | TDD |
| n261 | 27500 MHz-28350 MHz | 27500 MHz-28350 MHz | TDD |
| nXXX | 57000 MHz-71000 MHz | 57000 MHz-71000 MHz | TDD |
| nYYY | 57000 MHz-66000 MHz | 57000 MHz-66000 MHz | TDD |
| nZZZ | 52600 MHz-57000 MHz | 52600 MHz-57000 MHz | TDD |

Based on examples of the first example of the present disclosure, examples of NR-ARFCN for operating band nXXX, nYYY, nZZZ may be proposed as an example of Table 14.

TABLE 14

| | | Uplink and Downlink |
|---|---|---|
| | ΔF_{Raster} | Range of N_{REF} |
| Operating Band | (kHz) | (First-<Step size>-Last) |
| n257 | 60 | 2054166-<1>-2104165 |
| | 120 | 2054167-<2>-2104165 |
| n258 | 60 | 2016667-<1>-2070832 |
| | 120 | 2016667-<2>-2070831 |
| n260 | 60 | 2229166-<1>-2279165 |
| | 120 | 2229167-<2>-2279165 |
| n261 | 60 | 2070833-<1>-2084999 |
| | 120 | 2070833-<2>-2084999 |
| nXXX | 120, 480, 960 | 2563333-<NOTE1>-2794997 |
| nYYY | 120, 480, 960 | 2563333-<NOTE1>-2711699 |
| nZZZ | 120, 480, 960 | 2490005-<NOTE2>-2561669 |

NOTE1:
Step size vector with length of 12: <832 832 832 832 832 832 848 832 832 832 832 832>
NOTE2:
Step size vector with length of 12: <832 832 832 832 832 832 832 832 832 832 848 832>

Note 1 and Note 2 in Table 14 are an example. Various step size vector may be used for NR-ARFCN

According to the first example of the present disclosure, 5G NR system with NR-ARFCN raster scheme where step size vector of <848 832 832 832 832 832 832 832 832 832 832 832> or any circularly shifter variant of the vector is used to down select the NR-ARFCN from global frequency raster. Herein, “down select” may mean selecting frequency locations based on NR-ARFCN sparser than frequency locations of default global frequency raster with step size 1 in Table 7.

For the sake of clarity the 12 circularly shifted alternatives may be listed as below:
<848 832 832 832 832 832 832 832 832 832 832 832>
<832 848 832 832 832 832 832 832 832 832 832 832>
<832 832 848 832 832 832 832 832 832 832 832 832>
<832 832 832 848 832 832 832 832 832 832 832 832>
<832 832 832 832 848 832 832 832 832 832 832 832>
<832 832 832 832 832 848 832 832 832 832 832 832>
<832 832 832 832 832 832 848 832 832 832 832 832>
<832 832 832 832 832 832 832 848 832 832 832 832>
<832 832 832 832 832 832 832 832 848 832 832 832>
<832 832 832 832 832 832 832 832 832 848 832 832>
<832 832 832 832 832 832 832 832 832 832 848 832>
<832 832 832 832 832 832 832 832 832 832 832 848>.

The relation between the NR-ARFCN and the RF reference frequency F_{REF} in MHz is given by the following equation: F_{REF}=F_{REF-Offs}+ΔF_{Global} (N_{REF}−N_{REF}-offs). Where F_{REF-Offs} and N_{Ref-Offs} are given in table 7 and N_{REF} may be the NR-ARFCN.

According to the first example of the present disclosure, First NR-ARFCN entry and Last NR-ARFCN entry and the step size vector alternative are selected in a way that minimizes the difference between the 50 MHz ideal raster and the NR-ARFCN raster with steps of 49.92 and 50.88 MHz corresponding with the 832 and 848 entries in the step size vector.

### 2. Second Example of the Present Disclosure

Channel raster and sync raster arrangement for un-licensed operation within FR2-2 needs to be studied.

The fixed RF channel raster with the step size of 1680 (100.8 MHz) may be used as baseline to define the channel raster for the unlicensed band. Accordingly, the channel raster numbers may be provided.

Whether the above description can support CA with different bandwidth combinations may be considered.

In Second example of the present disclosure, descriptions and proposals for channel and synchronization raster for 57-71 GHz frequency range may be explained. For example, following two examples of proposal may be considered:
First one may be that utilizing the floating 960 kHz ARFCN raster and ˜100 MHz (combination of 99.86/100.8 MHz) SSB raster for 120 kHz SCS. SSB raster(e.g. sync raster) locations for 480 k SCS are down selected from 120 kHz SCS SSB raster. This proposal utilizes the full 14 000 MHz of spectrum and provides a lot of freedom for selecting the channel frequencies and flexibility for intra-band CA combinations; and/or
Second one may use the 100.8 MHz fixed ARFCN and SSB raster. SSB raster locations for 480 k SCS are down selected from 120 kHz SCS SSB raster. RF channels may be selected in a way that they target maximization of the spectrum usage and enable flexibility for difference CA combinations. Additional channel locations may be added for alignment with 802.11 channels.

Second example of the present disclosure may be described in more detail with the following sections 1-1 and 1-2.

For example, channel raster and SSB ra.ster for 57-71 GHz frequency range may be explained with the following 1.1 and 1.2.

### 1-1. First Example of Proposal

ARFCN raster may be proposed as the following.

Channel raster step size of 960 kHz, which is the same as the largest supported SCS, may be used. Use of 960 kHz is also aligning with channel raster based on 100.8 MHz. For example, 105 times 960 kHz may be aligned with 100 MHz, such as 105*0.96=100.8 MHz. But also use of 960 kHz supports other alternatives that enable more options for positioning of the channels and flexibility for intra-band CA configurations.

More detailed analysis and the start/end points for frequency range 57-71 GHz (n263) may be shown below. Nref=2 563 339, which corresponds to Center Frequency (CF)=57 050.40 MHz, may be selected as lowest channel location. For example, CF may be center frequency for the channel and may be same as F_{REF}. All other channel locations may have offset that is multiple of <16> from this one (16×60 kHz=960 kHz).

Last channel location has Nref=2 794 987, which corresponds to CF=70 949.28 MHz and the number of channel locations within FR2-2 band may be (2 563 339−2 490 011)/16+1=14 479.

For 480 k SCS and 960 kHz SCS, the lowest channel center frequency and highest channel center frequency are 200 MHz away from the band edge, which is half of the 400 MHz minimum CBW.

All the proposed channel raster entries have frequency offset to GSCN grid, which is a multiple of the 960 kHz, and hence the NRU(NR Unlicensed) type of wide-band operation is possible.

TABLE 15

| | Min | | | | | |
|---|---|---|---|---|---|---|
| | CBW | | Fc Low | | Fc High | |
| | (MHz) | N Low | (MHz) | N High | (MHz) | n |
| 120k SCS | 100 | 2 563 339 | 57050.4 | 2 794 987 | 70949.28 | 14479 |
| 480k SCS | 400 | 2 565 835 | 57200.16 | 2 792 491 | 70799.52 | 14167 |
| 960k SCS | 400 | 2 565 835 | 57200.16 | 2 792 491 | 70799.52 | 14167 |

Table 15 shows minimum Channel bandwidth (CBW), N Low, Fc Low, N High, Fc High, and n according to SCS.
N Low may mean Lowest channel number in this range
Fc Low, may mean F_{ref} that corresponds to channel number N low
N High, may mean Highest channel number in this range
Fc High, may mean Fref, that corresponds to channel number N high
n may mean number of raster locations in this range
NR operating band in FR2 may be based on examples of Table 4.

Examples of NR-ARFCN for operating band n263 according to the first example of proposal may be proposed as an example of Table 16.

TABLE 16

| | | Uplink and Downlink |
|---|---|---|
| | ΔF_{Raster} | Range of N_{REF} |
| Operating Band | (kHz) | (First-<Step size>-Last) |
| n257 | 60 | 2054166-<1>-2104165 |
| | 120 | 2054167-<2>-2104165 |
| n258 | 60 | 2016667-<1>-2070832 |
| | 120 | 2016667-<2>-2070831 |
| n260 | 60 | 2229166-<1>-2279165 |
| | 120 | 2229167-<2>-2279165 |
| n261 | 60 | 2070833-<1>-2084999 |
| | 120 | 2070833-<2>-2084999 |
| n263 | 120 | 2563339-<16>-2794987 |
| | 480 | 2565835-<16>-2792491 |
| | 960 | 2565835-<16>-2792491 |

Table 16 shows example of applicable NR-ARFCN per operating an.

SSB raster may be proposed as the following.

A global synchronization raster defined in prior art (e.g. 3GPP TS 38.101-2 V17.2.0) can be used as starting point also for FR2-2. The specified GSCN frequency range already covers the 57 to 71 GHz frequency range and 17.28 MHz step size may be suitable for 100 and 400 MHz minimum channel bandwidths agreed for 120 kHz and 480 kHz SCS respectively.

In order to limit the number of the SSB locations and simplify the cell search complexity one 120 k SCS SSB location is defined for each 100 MHz of spectrum. This leads to 140 SSB locations with 120 k SCS.

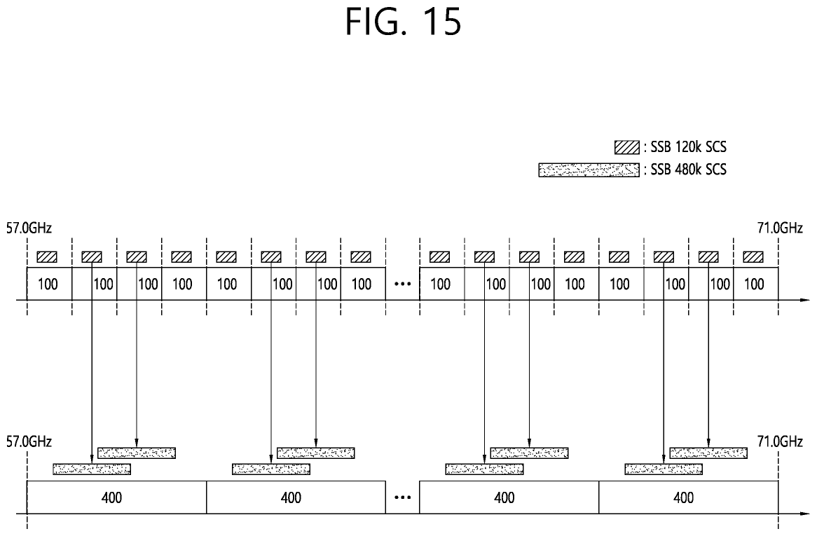

For 480 k SCS and each 400 MHz of spectrum two SSB locations are defined. SSB locations for 400 MHz are down selected from 120 kHz SSB raster as shown in FIG. 15.

The following drawings are prepared to explain a specific example of the present specification. Since the names of specific devices or names of specific signals/messages/fields described in the drawings are provided by way of example, technical features of the present specification are not limited to specific names used in the following drawings.

FIG. 15 illustrates an example of selected GSCN location for 100 MHz channels and 400 MHz channels according to the present disclosure.

FIG. 15 explains selection of GSCN locations for 100 MHz channels and further explains down-selection for 400 MHz.

The down-selection of the global SSB raster for 100 MHz channels can be done with step size vector with length of 19 and values of <6 6 6 6 5 6 6 6 6 5 6 6 6 5 6 6 6 6 5>.

In order to align the GSCN raster with ARFCN raster to support wide-band operation as in NRU (NR Unlicensed) a starting point of 24153 may be selected. For 480 k SCS with further down-selected entries (from 100 MHz locations) the 70 locations can be listed in the specification and are shown in Table 17 below.

TABLE 17

| NR | | | |
|---|---|---|---|
| Operating | SS Block | SS Block pattern | Range of GSCN |
| Band | SCS | (NOTE 1 applied) | _{(First-<Step} size>-Last) |
| n263 | 120 kHz | Case D | 24153 <NOTE2> |
| 57-71 GHz | | | 24958 |
| | 480 kHz | Case F | 24153 <NOTE2> |
| | | | 24958 |
| | 960 kHz | Case G | 24153 <NOTE2> |
| | | | 24958 |

NOTE1:
SS Block pattern is defined in sub clause 4.1 in 3GPP TS 38.213 V17.1.0
NOTE2:
Step size vector with length of 19: <6 6 6 6 5 6 6 6 6 5 6 6 6 5 6 6 6 6 5>
NOTE3:
The following GSCN are allowed for 480 kHz and 960 kHz primary cell (Pcell) and secondary cell (SCell) operation in band n263: for 480 kHz, GSCN = {24159, 24165, 24182, 24188, 24206, 24211, 24229, 24234, 24252, 24258, 24275, 24281, 24298, 24304, 24321, 24327, 24344, 24350, 24368, 24373, 24391, 24397, 24414, 24420, 24437, 24443, 24460, 24466, 24483, 24489, 24507, 24512, 24530, 24536, 24553, 24559, 24576, 24582, 24599, 24605, 24622, 24628, 24646, 24651, 24669, 24674, 24692, 24698, 24715, 24721, 24738, 24744, 24761, 24767, 24784, 24790, 24808, 24813, 24831, 24837, 24854, 24860, 24877, 24883, 24900, 24906, 24923, 24929, 24947, 24952} for 960 kHz, no applicable SS raster entries exist for PCell and PScell.

Table 17 shows examples of applicable Synchronization Signal (SS) raster entries per operating band (FR2).

Based on the examples of table 17, the total number of SS raster entries is 210 as shown in Table 18.

TABLE 18

| | Channels | Locations per channel | Total |
|---|---|---|---|
| 120k SCS | 140 | 1 | 140 |
| 480k SCS | 35 | 2 | 70 |
| TOTAL | | | 210 |

Table 18 shows example of number of SS raster entries.

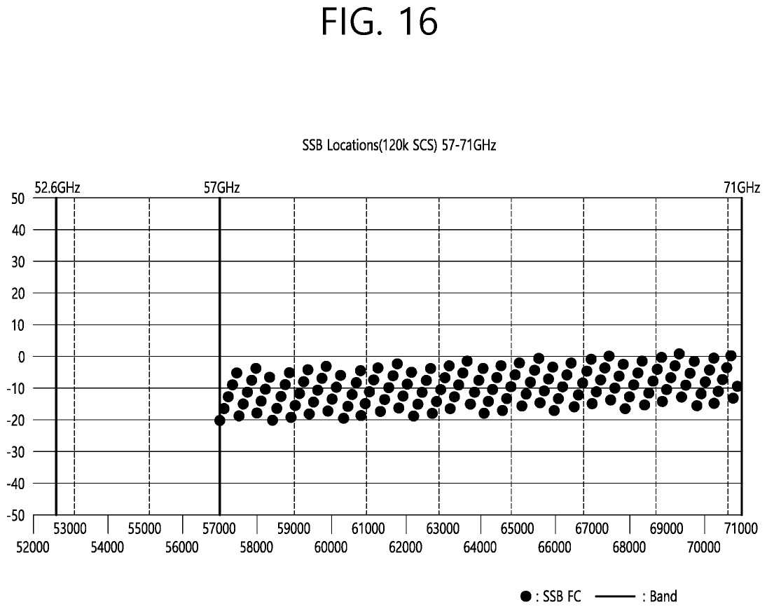

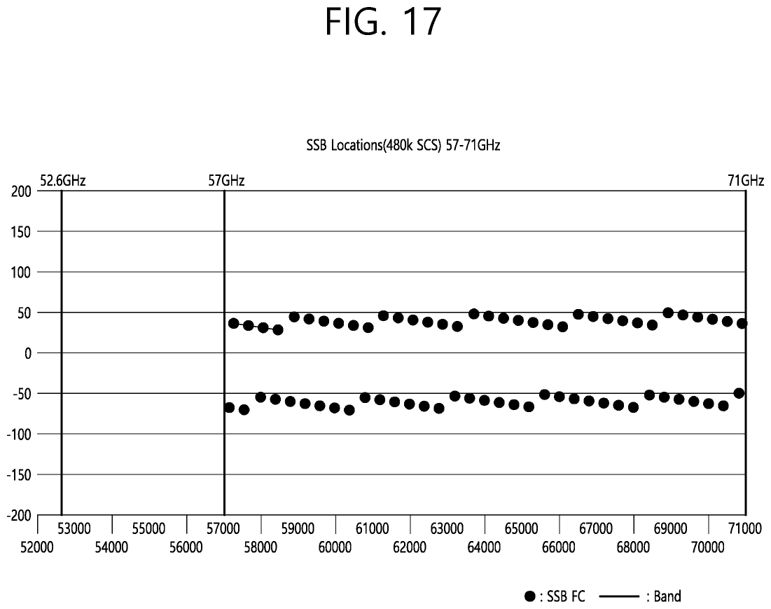

FIG. 16 and FIG. 17 below show how the SSBs falls inside the 100 MHz and 400 MHz channels when defined as in Table 17.

The following drawings are prepared to explain a specific example of the present specification. Since the names of specific devices or names of specific signals/messages/fields described in the drawings are provided by way of example, technical features of the present specification are not limited to specific names used in the following drawings.

FIG. 16 illustrates an example of SSB center frequency locations within 100 MHz CBW according to the present disclosure. FIG. 17 illustrates an example of SSB center frequency locations within 400 MHz CBW according to the present disclosure.

In FIG. 16 and FIG. 17, Fc, which is center frequency, of SSB proposed in the first example of proposal. FIG. 16 is related to 120 kHz SCS and 100 MHz CBW. FIG. 17 is related to 480 kHz SCS and 400 MHz CBW.

FIG. 16 and FIG. 17 shows examples of the location of the SSB center frequency within the band (X-axis). Y-axis may show where this is located within ideal 100 MHz or 4*100=400 MHz ranges of spectrum for 120 kHz and 480 kHz SCS respectively. As shown in these figures, as the SSB raster is more sparse than the ARFCN raster the location of the SSB drifts within the channel. In NR system the SSB does not need to be located at the center of the channel.

The width of the upper and lower guard-band (gap between SSB and channel edge) are always larger than the minimum guard-bands currently defined in prior arts, which are 2.42 MHz for 100 MHz and 9.86 MHz for 400 MHz CBW.

List of SSB locations for 120 kHz and 480 kHz SCS for first example of proposal is shown in Table 19.

TABLE 19

| 100 | | | | GSCN | 400 | GSCN |
|---|---|---|---|---|---|---|
| MHz | | Channel | Channel | 120k | MHZ | 480k |
| CH# | ARFCN | low | High | SCS | CH# | SCS |
| 1 | 2 563 339 | 57 000.40 | 57 100.40 | 24 153 | | |
| 2 | 2 565 003 | 57 100.24 | 57 200.24 | 24 159 | 1 | 24 159 |
| 3 | 2 566 667 | 57 200.08 | 57 300.08 | 24 165 | 1 | 24 165 |
| 4 | 2 568 331 | 57 299.92 | 57 399.92 | 24 171 | | |
| 5 | 2 569 995 | 57 399.76 | 57 499.76 | 24 177 | | |
| 6 | 2 571 659 | 57 499.60 | 57 599.60 | 24 182 | 2 | 24 182 |
| 7 | 2 573 339 | 57 600.40 | 57 700.40 | 24 188 | 2 | 24 188 |
| 8 | 2 575 003 | 57 700.24 | 57 800.24 | 24 194 | | |
| 9 | 2 576 667 | 57 800.08 | 57 900.08 | 24 200 | | |
| 10 | 2 578 331 | 57 899.92 | 57 999.92 | 24 206 | 3 | 24 206 |
| 11 | 2 579 995 | 57 999.76 | 58 099.76 | 24 211 | 3 | 24 211 |
| 12 | 2 581 659 | 58 099.60 | 58 199.60 | 24 217 | | |
| 13 | 2 583 339 | 58 200.40 | 58 300.40 | 24 223 | | |
| 14 | 2 585 003 | 58 300.24 | 58 400.24 | 24 229 | 4 | 24 229 |
| 15 | 2 586 667 | 58 400.08 | 58 500.08 | 24 234 | 4 | 24 234 |
| 16 | 2 588 331 | 58 499.92 | 58 599.92 | 24 240 | | |
| 17 | 2 589 995 | 58 599.76 | 58 699.76 | 24 246 | | |
| 18 | 2 591 659 | 58 699.60 | 58 799.60 | 24 252 | 5 | 24 252 |
| 19 | 2 593 339 | 58 800.40 | 58 900.40 | 24 258 | 5 | 24 258 |
| 20 | 2 595 003 | 58 900.24 | 59 000.24 | 24 263 | | |
| 21 | 2 596 667 | 59 000.08 | 59 100.08 | 24 269 | | |
| 22 | 2 598 331 | 59 099.92 | 59 199.92 | 24 275 | 6 | 24 275 |
| 23 | 2 599 995 | 59 199.76 | 59 299.76 | 24 281 | 6 | 24 281 |
| 24 | 2 601 659 | 59 299.60 | 59 399.60 | 24 287 | | |
| 25 | 2 603 339 | 59 400.40 | 59 500.40 | 24 292 | | |
| 26 | 2 605 003 | 59 500.24 | 59 600.24 | 24 298 | 7 | 24 298 |
| 27 | 2 606 667 | 59 600.08 | 59 700.08 | 24 304 | 7 | 24 304 |
| 28 | 2 608 331 | 59 699.92 | 59 799.92 | 24 310 | | |
| 29 | 2 609 995 | 59 799.76 | 59 899.76 | 24 316 | | |
| 30 | 2 611 659 | 59 899.60 | 59 999.60 | 24 321 | 8 | 24 321 |
| 31 | 2 613 339 | 60 000.40 | 60 100.40 | 24 327 | 8 | 24 327 |
| 32 | 2 615 003 | 60 100.24 | 60 200.24 | 24 333 | | |
| 33 | 2 616 667 | 60 200.08 | 60 300.08 | 24 339 | | |
| 34 | 2 618 331 | 60 299.92 | 60 399.92 | 24 344 | 9 | 24 344 |
| 35 | 2 619 995 | 60 399.76 | 60 499.76 | 24 350 | 9 | 24 350 |
| 36 | 2 621 659 | 60 499.60 | 60 599.60 | 24 356 | | |
| 37 | 2 623 339 | 60 600.40 | 60 700.40 | 24 362 | | |
| 38 | 2 625 003 | 60 700.24 | 60 800.24 | 24 368 | 10 | 24 368 |
| 39 | 2 626 667 | 60 800.08 | 60 900.08 | 24 373 | 10 | 24 373 |
| 40 | 2 628 331 | 60 899.92 | 60 999.92 | 24 379 | | |
| 41 | 2 629 995 | 60 999.76 | 61 099.76 | 24 385 | | |
| 42 | 2 631 659 | 61 099.60 | 61 199.60 | 24 391 | 11 | 24 391 |
| 43 | 2 633 339 | 61 200.40 | 61 300.40 | 24 397 | 11 | 24 397 |
| 44 | 2 635 003 | 61 300.24 | 61 400.24 | 24 402 | | |
| 45 | 2 636 667 | 61 400.08 | 61 500.08 | 24 408 | | |
| 46 | 2 638 331 | 61 499.92 | 61 599.92 | 24 414 | 12 | 24 414 |
| 47 | 2 639 995 | 61 599.76 | 61 699.76 | 24 420 | 12 | 24 420 |
| 48 | 2 641 659 | 61 699.60 | 61 799.60 | 24 426 | | |
| 49 | 2 643 339 | 61 800.40 | 61 900.40 | 24 431 | | |
| 50 | 2 645 003 | 61 900.24 | 62 000.24 | 24 437 | 13 | 24 437 |
| 51 | 2 646 667 | 62 000.08 | 62 100.08 | 24 443 | 13 | 24 443 |
| 52 | 2 648 331 | 62 099.92 | 62 199.92 | 24 449 | | |
| 53 | 2 649 995 | 62 199.76 | 62 299.76 | 24 454 | | |
| 54 | 2 651 659 | 62 299.60 | 62 399.60 | 24 460 | 14 | 24 460 |
| 55 | 2 653 339 | 62 400.40 | 62 500.40 | 24 466 | 14 | 24 466 |
| 56 | 2 655 003 | 62 500.24 | 62 600.24 | 24 472 | | |
| 57 | 2 656 667 | 62 600.08 | 62 700.08 | 24 478 | | |
| 58 | 2 658 331 | 62 699.92 | 62 799.92 | 24 483 | 15 | 24 483 |
| 59 | 2 659 995 | 62 799.76 | 62 899.76 | 24 489 | 15 | 24 489 |
| 60 | 2 661 659 | 62 899.60 | 62 999.60 | 24 495 | | |
| 61 | 2 663 339 | 63 000.40 | 63 100.40 | 24 501 | | |
| 62 | 2 665 003 | 63 100.24 | 63 200.24 | 24 507 | 16 | 24 507 |
| 63 | 2 666 667 | 63 200.08 | 63 300.08 | 24 512 | 16 | 24 512 |
| 64 | 2 668 331 | 63 299.92 | 63 399.92 | 24 518 | | |
| 65 | 2 669 995 | 63 399.76 | 63 499.76 | 24 524 | | |
| 66 | 2 671 659 | 63 499.60 | 63 599.60 | 24 530 | 17 | 24 530 |
| 67 | 2 673 339 | 63 600.40 | 63 700.40 | 24 536 | 17 | 24 536 |
| 68 | 2 675 003 | 63 700.24 | 63 800.24 | 24 541 | | |
| 69 | 2 676 667 | 63 800.08 | 63 900.08 | 24 547 | | |
| 70 | 2 678 331 | 63 899.92 | 63 999.92 | 24 553 | 18 | 24 553 |
| 71 | 2 679 995 | 63 999.76 | 64 099.76 | 24 559 | 18 | 24 559 |
| 72 | 2 681 659 | 64 099.60 | 64 199.60 | 24 564 | | |
| 73 | 2 683 339 | 64 200.40 | 64 300.40 | 24 570 | | |
| 74 | 2 685 003 | 64 300.24 | 64 400.24 | 24 576 | 19 | 24 576 |
| 75 | 2 686 667 | 64 400.08 | 64 500.08 | 24 582 | 19 | 24 582 |
| 76 | 2 688 331 | 64 499.92 | 64 599.92 | 24 588 | | |
| 77 | 2 689 995 | 64 599.76 | 64 699.76 | 24 593 | | |
| 78 | 2 691 659 | 64 699.60 | 64 799.60 | 24 599 | 20 | 24 599 |
| 79 | 2 693 339 | 64 800.40 | 64 900.40 | 24 605 | 20 | 24 605 |
| 80 | 2 695 003 | 64 900.24 | 65 000.24 | 24 611 | | |
| 81 | 2 696 667 | 65 000.08 | 65 100.08 | 24 617 | | |
| 82 | 2 698 331 | 65 099.92 | 65 199.92 | 24 622 | 21 | 24 622 |
| 83 | 2 699 995 | 65 199.76 | 65 299.76 | 24 628 | 21 | 24 628 |
| 84 | 2 701 659 | 65 299.60 | 65 399.60 | 24 634 | | |
| 85 | 2 703 339 | 65 400.40 | 65 500.40 | 24 640 | | |
| 86 | 2 705 003 | 65 500.24 | 65 600.24 | 24 646 | 22 | 24 646 |
| 87 | 2 706 667 | 65 600.08 | 65 700.08 | 24 651 | 22 | 24 651 |
| 88 | 2 708 331 | 65 699.92 | 65 799.92 | 24 657 | | |
| 89 | 2 709 995 | 65 799.76 | 65 899.76 | 24 663 | | |
| 90 | 2 711 659 | 65 899.60 | 65 999.60 | 24 669 | 23 | 24 669 |
| 91 | 2 713 339 | 66 000.40 | 66 100.40 | 24 674 | 23 | 24 674 |
| 92 | 2 715 003 | 66 100.24 | 66 200.24 | 24 680 | | |
| 93 | 2 716 667 | 66 200.08 | 66 300.08 | 24 686 | | |
| 94 | 2 718 331 | 66 299.92 | 66 399.92 | 24 692 | 24 | 24 692 |
| 95 | 2 719 995 | 66 399.76 | 66 499.76 | 24 698 | 24 | 24 698 |
| 96 | 2 721 659 | 66 499.60 | 66 599.60 | 24 703 | | |
| 97 | 2 723 339 | 66 600.40 | 66 700.40 | 24 709 | | |
| 98 | 2 725 003 | 66 700.24 | 66 800.24 | 24 715 | 25 | 24 715 |
| 99 | 2 726 667 | 66 800.08 | 66 900.08 | 24 721 | 25 | 24 721 |
| 100 | 2 728 331 | 66 899.92 | 66 999.92 | 24 727 | | |
| 101 | 2 729 995 | 66 999.76 | 67 099.76 | 24 732 | | |
| 102 | 2 731 659 | 67 099.60 | 67 199.60 | 24 738 | 26 | 24 738 |
| 103 | 2 733 339 | 67 200.40 | 67 300.40 | 24 744 | 26 | 24 744 |
| 104 | 2 735 003 | 67 300.24 | 67 400.24 | 24 750 | | |
| 105 | 2 736 667 | 67 400.08 | 67 500.08 | 24 756 | | |
| 106 | 2 738 331 | 67 499.92 | 67 599.92 | 24 761 | 27 | 24 761 |
| 107 | 2 739 995 | 67 599.76 | 67 699.76 | 24 767 | 27 | 24 767 |
| 108 | 2 741 659 | 67 699.60 | 67 799.60 | 24 773 | | |
| 109 | 2 743 339 | 67 800.40 | 67 900.40 | 24 779 | | |
| 110 | 2 745 003 | 67 900.24 | 68 000.24 | 24 784 | 28 | 24 784 |
| 111 | 2 746 667 | 68 000.08 | 68 100.08 | 24 790 | 28 | 24 790 |
| 112 | 2 748 331 | 68 099.92 | 68 199.92 | 24 796 | | |
| 113 | 2 749 995 | 68 199.76 | 68 299.76 | 24 802 | | |
| 114 | 2 751 659 | 68 299.60 | 68 399.60 | 24 808 | 29 | 24 808 |
| 115 | 2 753 339 | 68 400.40 | 68 500.40 | 24 813 | 29 | 24 813 |
| 116 | 2 755 003 | 68 500.24 | 68 600.24 | 24 819 | | |
| 117 | 2 756 667 | 68 600.08 | 68 700.08 | 24 825 | | |
| 118 | 2 758 331 | 68 699.92 | 68 799.92 | 24 831 | 30 | 24 831 |
| 119 | 2 759 995 | 68 799.76 | 68 899.76 | 24 837 | 30 | 24 837 |
| 120 | 2 761 659 | 68 899.60 | 68 999.60 | 24 842 | | |
| 121 | 2 763 339 | 69 000.40 | 69 100.40 | 24 848 | | |
| 122 | 2 765 003 | 69 100.24 | 69 200.24 | 24 854 | 31 | 24 854 |
| 123 | 2 766 667 | 69 200.08 | 69 300.08 | 24 860 | 31 | 24 860 |
| 124 | 2 768 331 | 69 299.92 | 69 399.92 | 24 866 | | |
| 125 | 2 769 995 | 69 399.76 | 69 499.76 | 24 871 | | |
| 126 | 2 771 659 | 69 499.60 | 69 599.60 | 24 877 | 32 | 24 877 |
| 127 | 2 773 339 | 69 600.40 | 69 700.40 | 24 883 | 32 | 24 883 |
| 128 | 2 775 003 | 69 700.24 | 69 800.24 | 24 889 | | |
| 129 | 2 776 667 | 69 800.08 | 69 900.08 | 24 894 | | |
| 130 | 2 778 331 | 69 899.92 | 69 999.92 | 24 900 | 33 | 24 900 |
| 131 | 2 779 995 | 69 999.76 | 70 099.76 | 24 906 | 33 | 24 906 |
| 132 | 2 781 659 | 70 099.60 | 70 199.60 | 24 912 | | |
| 133 | 2 783 339 | 70 200.40 | 70 300.40 | 24 918 | | |
| 134 | 2 785 003 | 70 300.24 | 70 400.24 | 24 923 | 34 | 24 923 |
| 135 | 2 786 667 | 70 400.08 | 70 500.08 | 24 929 | 34 | 24 929 |
| 136 | 2 788 331 | 70 499.92 | 70 599.92 | 24 935 | | |
| 137 | 2 789 995 | 70 599.76 | 70 699.76 | 24 941 | | |
| 138 | 2 791 659 | 70 699.60 | 70 799.60 | 24 947 | 35 | 24 947 |
| 139 | 2 793 339 | 70 800.40 | 70 900.40 | 24 952 | 35 | 24 952 |
| 140 | 2 794 987 | 70 899.28 | 70 999.28 | 24 958 | | |

Table 19 shows examples of SSB locations for n263 band.

ARFCN from 960 k floating raster for the table 19 has been selected in a way that delta between the channel center frequency and the center frequency of each 100 MHz spectrum block is minimized.

### 1-2. Second Example of Proposal

ARFCN raster may be proposed as the following.

Fixed channel raster step size of 100.8 MHz may be used.

ARFCN=2564083, which corresponds to CF=57095.04 MHz, has been selected as lowest channel location. All other 100.8 MHz channel locations are having offset that is multiple of <1680> from this one (1680×60 kHz=100.8 MHz). Last channel location has ARFCN=2 794 243, which corresponds to CF=70 904.64 MHz and the number of channel locations within FR2-2 band is 138.

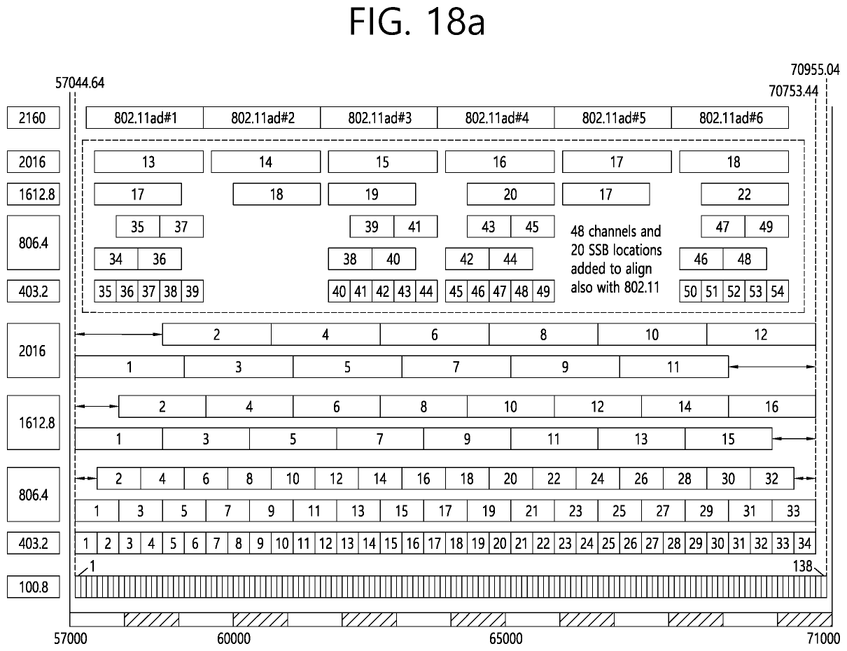

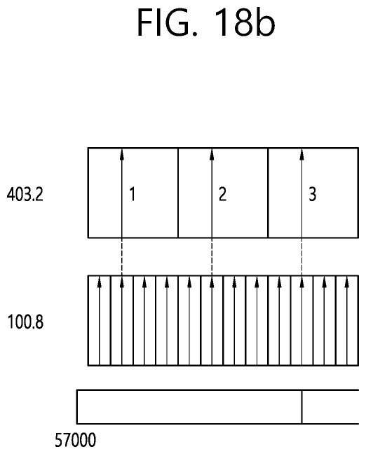

Wider channels are proposed to be located as shown in FIG. 18a below.

The following drawings are prepared to explain a specific example of the present specification. Since the names of specific devices or names of specific signals/messages/fields described in the drawings are provided by way of example, technical features of the present specification are not limited to specific names used in the following drawings.

FIG. 18a illustrates an example of channels based on channel raster according to the second example of the present disclosure.

According to FIG. 18a, squares on the top line means channels based on Wi-Fi standard 802.1 lad.

Numbers written on the left side of the figure may mean channel raster spacing based on MHz unit.

First 34+33+16+12 channels (with 403.2, 806.4, 1612.8 and 2016 raster) are placed with intent to utilize as much spectrum as possible and enable flexible support for intra-band CA. For example, for 403.2 channel raster on the lower part may mean channels are spaced apart from each other by 403.2 MHZ, and total number of the channels may be 34.

In addition, 20+16+6+6 channels (with 403.2, 806.4, 1612.8 and 2016 MHz raster) are added for alignment with 802.11. These additional channels are needed to align with 802.11ad channels 1, 3, 4 and 6 while baseline channels can be used for alignment with 802.11ad channels 2 and 5. For example, for 403.2 channel raster on the upper part may mean channels are spaced apart from each other by 403.2 MHz, and total number of the channels may be 20 with numbers started from 35 to 54.

For reference, left right arrow in FIG. 18a may mean frequency gap between 57044.64 MHz from the channel edge, or frequency gap between 70753.44 MHz from the channel edge. For example, the left right arrow with 2016 raster may mean 1612.8 MHz of frequency gap. For example, the left right arrow with 1612.8 MHz raster may mean 806.5 MHz of frequency gap. For example, the left right arrow with 806.4 MHz raster may mean 403.2 MHz of frequency gap.

The total number of channels 233+48=281 becomes altogether.

Number of channels in FIG. 18a are summarized as the following Table 20.

TABLE 20

| | CBW | | | | |
|---|---|---|---|---|---|
| SCS | 100.8 MHz | 403.2 MHz | 806.4 MHz | 1612.8 MHz | 2016 MHz |
| 120 kHz | 138 | 34 + 20 = 54 | N/A | N/A | N/A |
| 480 kHz | N/A | | 33 + 16 = 49 | 16 + 6 = 22 | N/A |
| 960 kHz | N/A | | | | 12 + 6 = 18 |

Table 20 shows example of number of channels for each (CBW, SCS) combination.

Chanel numbers of Table 20 may be derived from the example of FIG. 18a.

Applicable NR-ARFCN based on the second example of proposal in the second example of the present disclosure may be shown as Table 21.

TABLE 21

| | | Uplink and Downlink |
|---|---|---|
| | ΔF_{Raster} | Range of N_{REF} |
| Operating Band | (kHz) | (First-<Step size>-Last) |
| n257 | 60 | 2054166-<1>-2104165 |
| | 120 | 2054167-<2>-2104165 |
| n258 | 60 | 2016667-<1>-2070832 |
| | 120 | 2016667-<2>-2070831 |
| n260 | 60 | 2229166-<1>-2279165 |
| | 120 | 2229167-<2>-2279165 |
| n261 | 60 | 2070833-<1>-2084999 |
| | 120 | 2070833-<2>-2084999 |
| n263 | 120 | 2564083-<1680>-2794243 |
| | 480 | 2566603-<1680>-2788363 |
| | 960 | 2566603-<1680>-2788363 |

NOTE 1:
Applicable NR-ARFCN for band n263 for 400 MHz channel bandwidth, NREF = {2566603, 2573323, 2580043, 2586763, 2593483, 2600203, 2606923, 2613643, 2620363, 2627083, 2633803, 2640523, 2647243, 2653963, 2660683, 2667403, 2674123, 2680843, 2687563, 2694283, 2701003, 2707723, 2714443, 2721163, 2727883, 2734603, 2741323, 2748043, 2754763, 2761483, 2768203, 2774923, 2781643, 2788363, 2571643, 2578363, 2585083, 2591803, 2598523, 2642203, 2648923, 2655643, 2662363, 2669083, 2679163, 2685883, 2692603, 2699323, 2706043, 2751403, 2758123, 2764843, 2771563, 2778283} for 800 MHz channel bandwidth, NREF = {2569963, 2576683, 2583403, 2590123, 2596843, 2603563, 2610283, 2617003, 2623723, 2630443, 2637163, 2643883, 2650603, 2657323, 2664043, 2670763, 2677483, 2684203, 2690923, 2697643, 2704363, 2711083, 2717803, 2724523, 2731243, 2737963, 2744683, 2751403, 2758123, 2764843, 2771563, 2778283, 2785003, 2575003, 2581723, 2588443, 2595163, 2645563, 2652283, 2659003, 2665723, 2682523, 2689243, 2695963, 2702683, 2754763, 2761483, 2768203, 2774923} for 1600 MHz channel bandwidth, NREF = {2576683, 2590123, 2603563, 2617003, 2630443, 2643883, 2657323, 2670763, 2684203, 2697643, 2711083, 2724523, 2737963, 2751403, 2764843, 2778283, 2581723, 2623723, 2652283, 2695963, 2724523, 2768203} for 2000 MHz channel bandwidth, NREF = {2576683, 2603563, 2610283, 2637163, 2643883, 2670763, 2677483, 2704363, 2711083, 2737963, 2744683, 2771563, 2585083, 2620363, 2655643, 2692603, 2727883, 2764843}

Table 21 shows example of applicable NR-ARFCN per operating band according to the second example of proposal in the second example of the present disclosure.

RF channel positions on channel raster in each NR operating band, e.g. operating band n263, may be given through the applicable NR-ARFCN in Table 21. Channel raster may define the RF reference frequencies also known as channel center frequencies that can be used to operate (e.g. to identify the RF channel position) in uplink and downlink in operating band n263. For example, RF channel position may be used, by the UE and/or a base station, to identify RF position based on RF reference frequency in operating band n263. RF channel positions on the channel raster in each NR operating band may be given through the applicable NR-ARFCN in the example of table 21. The applicable NR-ARFCN in the operating band n263 is based on channel bandwidth, which is one of 400 MHz, 800 MHz, 1600 MHz, or 2000 MHz. Based on that channel bandwidth is 400 MHz, 800 MHz, 1600 MHz, or 2000 MHz for the operating band n263, the applicable NR-ARFCN may include one or more of NR-ARFCNs being spaced apart each other by 6720*N, as shown in NOTE 1 of Table 21.

For example, Applicable NR-ARFCN for band n263 for 400 MHz channel bandwidth, N_{REF} may be at least one of {2566603, 2573323, 2580043, 2586763, 2593483, 2600203, 2606923, 2613643, 2620363, 2627083, 2633803, 2640523, 2647243, 2653963, 2660683, 2667403, 2674123, 2680843, 2687563, 2694283, 2701003, 2707723, 2714443, 2721163, 2727883, 2734603, 2741323, 2748043, 2754763, 2761483, 2768203, 2774923, 2781643, 2788363, 2571643, 2578363, 2585083, 2591803, 2598523, 2642203, 2648923, 2655643, 2662363, 2669083, 2679163, 2685883, 2692603, 2699323, 2706043, 2751403, 2758123, 2764843, 2771563, 2778283}.

For example, Applicable NR-ARFCN for band n263 for 800 MHz channel bandwidth, N_{REF} may be at least one of {2569963, 2576683, 2583403, 2590123, 2596843, 2603563, 2610283, 2617003, 2623723, 2630443, 2637163, 2643883, 2650603, 2657323, 2664043, 2670763, 2677483, 2684203, 2690923, 2697643, 2704363, 2711083, 2717803, 2724523, 2731243, 2737963, 2744683, 2751403, 2758123, 2764843, 2771563, 2778283, 2785003, 2575003, 2581723, 2588443, 2595163, 2645563, 2652283, 2659003, 2665723, 2682523, 2689243, 2695963, 2702683, 2754763, 2761483, 2768203, 2774923}.

For example, Applicable NR-ARFCN for band n263 for 1600 MHz channel bandwidth, N_{REF} may be at least one of {2576683, 2590123, 2603563, 2617003, 2630443, 2643883, 2657323, 2670763, 2684203, 2697643, 2711083, 2724523, 2737963, 2751403, 2764843, 2778283, 2581723, 2623723, 2652283, 2695963, 2724523, 2768203}.

For example, Applicable NR-ARFCN for 2000 MHz channel bandwidth, N_{REF} may be at least one of {2576683, 2603563, 2610283, 2637163, 2643883, 2670763, 2677483, 2704363, 2711083, 2737963, 2744683, 2771563, 2585083, 2620363, 2655643, 2692603, 2727883, 2764843}.

For example, all or some of the applicable NR-ARFCN shown in Table 21 may expressed as the following. Based on that channel bandwidth is 400 MHz for the operating band n263, the applicable NR-ARFCN may be equal to 2566603+6720*N. For example, for channel bandwidth of 400 MHz, 2566603, 2573323, 2580043, 2586763, 2593483, 2600203, 2606923, 2613643, 2620363, 2627083, 2633803, 2640523, 2647243, 2653963, 2660683, 2667403, 2674123, 2680843, 2687563, 2694283, 2701003, 2707723, 2714443, 2721163, 2727883, 2734603, 2741323, 2748043, 2754763, 2761483, 2768203, 2774923, 2781643, 2788363, 2571643, 2578363, are spaced apart from each other as multiple of 6720 (6720*N). Based on that channel bandwidth is 800 MHz for the operating band n263, the applicable NR-ARFCN may be equal to 2569963+6720*N. For example, for channel bandwidth of 800 MHz, 2569963, 2576683, 2583403, 2590123, 2596843, 2603563, 2610283, 2617003, 2623723, 2630443, 2637163, 2643883, 2650603, 2657323, 2664043, 2670763, 2677483, 2684203, 2690923, 2697643, 2704363, 2711083, 2717803, 2724523, 2731243, 2737963, 2744683, 2751403, 2758123, 2764843, 2771563, 2778283, 2785003, are spaced apart from each other as multiple of 6720 (6720*N). Based on that channel bandwidth is 1600 MHz for the operating band n263, the applicable NR-ARFCN may be equal to 2576683+6720*N. For example, for channel bandwidth of 1600 MHz, 2576683, 2590123, 2603563, 2617003, 2630443, 2643883, 2657323, 2670763, 2684203, 2697643, 2711083, 2724523, 2737963, 2751403, 2764843, 2778283 are spaced apart from each other as multiple of 13440, which is twice of 6720, (thus, 6720*N).

SSB raster may be proposed as the following.

In order to limit the number of the SSB locations and simplify the cell search complexity one 120 k SCS SSB location is defined for each 100.8 MHz channel. This leads to 138 SSB locations with 120 k SCS.

For 480 k SCS and 403.2 MHz channels one SSB location is also defined. SSB locations for 403.2 MHz channels are down selected from 120 kHz SSBs in a way that raster location of the 2nd 100.8 MHz channel inside each 403.2 MHz is used for SSB locations for 403.2 MHz channels, as shown in FIG. 18b.

The following drawings are prepared to explain a specific example of the present specification. Since the names of specific devices or names of specific signals/messages/fields described in the drawings are provided by way of example, technical features of the present specification are not limited to specific names used in the following drawings.

FIG. 18b illustrates an example of GSCN selection according to the second example of the present disclosure.

For 806.4, 1612.8 and 2016 MHz channels, the GSCN locations of the 403.2 MHz channels may be reused.

FIG. 18b shows GSCN down-selection principle for 480 kHz SSBs. FIG. 18b may be based on FIG. 18a.

For 480 k SCS and 403.2 MHz channels one SSB location is also defined. SSB locations for 403.2 MHz channels are down selected from 120 kHz SSBs in a way that raster location of the 2nd 100.8 MHz channel inside each 403.2 MHz is reused as shown in FIG. 18b.

Table 22 shows SS raster entries.

TABLE 22

| NR | | SS Block | |
|---|---|---|---|
| Operating | SS Block | pattern | Range of GSCN |
| Band | SCS | (NOTE 1 applied) | _{(First-<Step size>}-Last) |
| n263 | 120 kHz | Case D | 24153 <NOTE3> 24956 |
| 57-71 GHz | 480 kHz | Case F | 24153 <NOTE3> 24956 |
| | 960 kHz | Case G | 24153 <NOTE3> 24956 |

NOTE1:
SS Block pattern is defined in sub clause 4.1 in 3GPP TS 38.213 V17.1.0
NOTE2:
Step size vector with length of 6: <6 5 6 6 6 6>
NOTE3:
The following GSCN are allowed for 480 kHz and 960 kHz Pcell and Scell operation in band n263: for 480 kHz, GSCN = {24163, 24180, 24186, 24203, 24209, 24227, 24233, 24250, 24256, 24273, 24279, 24303, 24326, 24349, 24373, 24396, 24419, 24425, 24443, 24448, 24466, 24472, 24489, 24495, 24513, 24518, 24536, 24553, 24559, 24577, 24583, 24600, 24606, 24623, 24629, 24647, 24653, 24676, 24699, 24723, 24746, 24769, 24793, 24804, 24816, 24828, 24839, 24851, 24863, 24874, 24886, 24898, 24909, 24933}. for 960 kHz, no applicable SS raster entries exist for PCell and PScell.

Table 22 shows examples of applicable Synchronization Sign SS raster entries per operating band (FR2).

With this approach the total number of SS raster entries is 192 as shown in Table 23.

TABLE 23

| | Channels | Locations per channel | Total |
|---|---|---|---|
| 120k SCS | 138 | 1 | 138 |
| 480k SCS | 54 | 1 | 54 |
| TOTAL | | | 192 |

Table 23 shows example of number of SS raster entries.

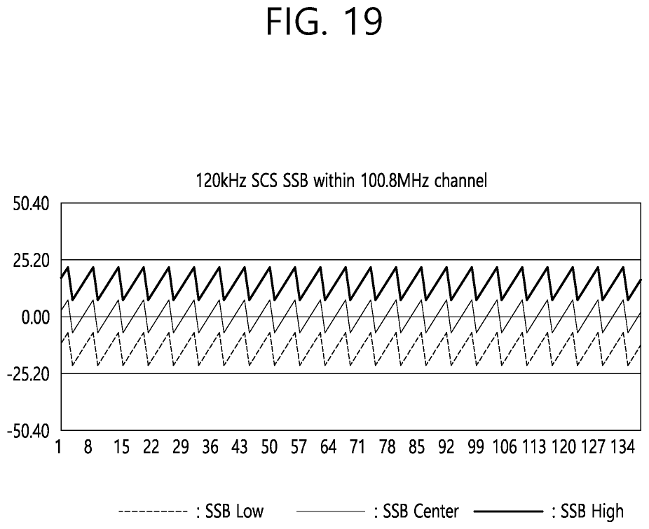

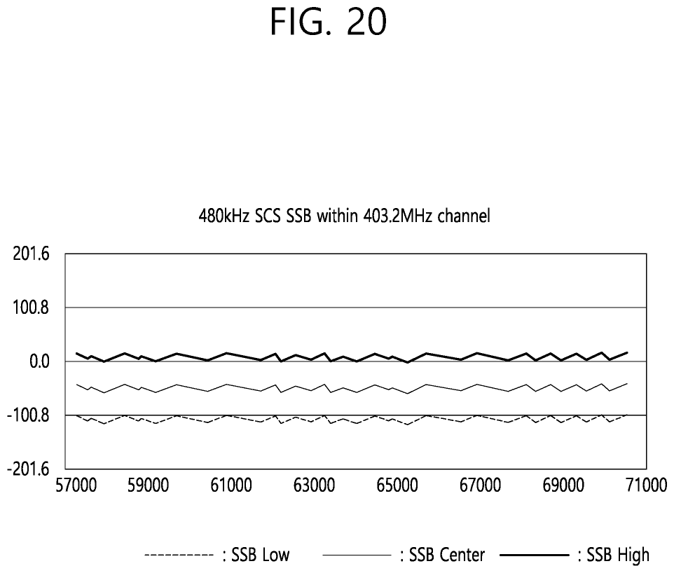

FIG. 19 and FIG. 20 below show how the SSBs falls inside the 100.8 MHz channels when defined as in Table 23.

The following drawings are prepared to explain a specific example of the present specification. Since the names of specific devices or names of specific signals/messages/fields described in the drawings are provided by way of example, technical features of the present specification are not limited to specific names used in the following drawings.

FIG. 19 illustrates an example of SSB center frequency locations within 100.8 MHz CBW according to the present disclosure. FIG. 20 illustrates an example of SSB center frequency locations within 403.2 MHz CBW according to the present disclosure.

In FIG. 19 and FIG. 20, SCS of 120 kHz and SCS of 480 kHz are applied respectively. SSB center means center frequency of SSB. SSB low may mean lower edge of SSB. SSB high may mean higher edge of SSB.

FIG. 19 and FIG. 20 shows examples of the location of the SSB center frequency within the band (X-axis). Y-axis may show where this is located within ideal 100.8 MHz or 4*100.8=403.2 MHz ranges of spectrum for 120 kHz and 480 kHz SCS respectively. As shown in these figures, as the SSB raster is more sparse than the ARFCN raster the location of the SSB drifts within the channel. For NR system SSB does not need to be located at the center of the channel.

FIG. 19 and FIG. 20 shows SSB center frequency locations within each 100.8 MHz and 403.2 MHz channels.

The width of the upper and lower guard-band (gap between SSB and channel edge). With 100.8 MHz channel raster and the 6 long step size vector <6 5 6 6 6 6> the SSB remains all the time in the center part of the channel as 35×17.28 MHz=6×100.8 MHz.

List of SSB locations for 120 kHz and 480 kHz SCS for second example of proposal is shown in Table 24.

TABLE 24

| | | | | | | | Added |
|---|---|---|---|---|---|---|---|
| | | | | | | | to align |
| 100.8 MHz | | Channel | Channel | GSCN | 403.2 MHZ | GSCN | with |
| CH# | ARFCN | low | High | 120k SCS | CH# | 480k SCS | 802.11 |
| 1 | 2 564 083 | 57 044.64 | 57 145.44 | 24 157 | | | |
| 2 | 2 565 763 | 57 145.44 | 57 246.24 | 24 163 | 1 | 24 163 | |
| 3 | 2 567 443 | 57 246.24 | 57 347.04 | 24 168 | | | |
| 4 | 2 569 123 | 57 347.04 | 57 447.84 | 24 174 | | | |
| 5 | 2 570 803 | 57 447.84 | 57 548.64 | 24 180 | 35 | 24 180 | X |
| 6 | 2 572 483 | 57 548.64 | 57 649.44 | 24 186 | 3 | 24 186 | |
| 7 | 2 574 163 | 57 649.44 | 57 750.24 | 24 192 | | | |
| 8 | 2 575 843 | 57 750.24 | 57 851.04 | 24 198 | | | |
| 9 | 2 577 523 | 57 851.04 | 57 951.84 | 24 203 | 36 | 24 203 | X |
| 10 | 2 579 203 | 57 951.84 | 58 052.64 | 24 209 | 3 | 24 209 | |
| 11 | 2 580 883 | 58 052.64 | 58 153.44 | 24 215 | | | |
| 12 | 2 582 563 | 58 153.44 | 58 254.24 | 24 221 | | | |
| 13 | 2 584 243 | 58 254.24 | 58 355.04 | 24 227 | 37 | 24 227 | X |
| 14 | 2 585 923 | 58 355.04 | 58 455.84 | 24 233 | 4 | 24 233 | |
| 15 | 2 587 603 | 58 455.84 | 58 556.64 | 24 238 | | | |
| 16 | 2 589 283 | 58 556.64 | 58 657.44 | 24 244 | | | |
| 17 | 2 590 963 | 58 657.44 | 58 758.24 | 24 250 | 38 | 24 250 | X |
| 18 | 2 592 643 | 58 758.24 | 58 859.04 | 24 256 | 5 | 24 256 | |
| 19 | 2 594 323 | 58 859.04 | 58 959.84 | 24 262 | | | |
| 20 | 2 596 003 | 58 959.84 | 59 060.64 | 24 268 | | | |
| 21 | 2 597 683 | 59 060.64 | 59 161.44 | 24 273 | 39 | 24 273 | X |
| 22 | 2 599 363 | 59 161.44 | 59 262.24 | 24 279 | 6 | 24 279 | |
| 23 | 2 601 043 | 59 262.24 | 59 363.04 | 24 285 | | | |
| 24 | 2 602 723 | 59 363.04 | 59 463.84 | 24 291 | | | |
| 25 | 2 604 403 | 59 463.84 | 59 564.64 | 24 297 | | | |
| 26 | 2 606 083 | 59 564.64 | 59 665.44 | 24 303 | 7 | 24 303 | |
| 27 | 2 607 763 | 59 665.44 | 59 766.24 | 24 308 | | | |
| 28 | 2 609 443 | 59 766.24 | 59 867.04 | 24 314 | | | |
| 29 | 2 611 123 | 59 867.04 | 59 967.84 | 24 320 | | | |
| 30 | 2 612 803 | 59 967.84 | 60 068.64 | 24 326 | 8 | 24 326 | |
| 31 | 2 614 483 | 60 068.64 | 60 169.44 | 24 332 | | | |
| 32 | 2 616 163 | 60 169.44 | 60 270.24 | 24 338 | | | |
| 33 | 2 617 843 | 60 270.24 | 60 371.04 | 24 343 | | | |
| 34 | 2 619 523 | 60 371.04 | 60 471.84 | 24 349 | 9 | 24 349 | |
| 35 | 2 621 203 | 60 471.84 | 60 572.64 | 24 355 | | | |
| 36 | 2 622 883 | 60 572.64 | 60 673.44 | 24 361 | | | |
| 37 | 2 624 563 | 60 673.44 | 60 774.24 | 24 367 | | | |
| 38 | 2 626 243 | 60 774.24 | 60 875.04 | 24 373 | 10 | 24 373 | |
| 39 | 2 627 923 | 60 875.04 | 60 975.84 | 24 378 | | | |
| 40 | 2 629 603 | 60 975.84 | 61 076.64 | 24 384 | | | |
| 41 | 2 631 283 | 61 076.64 | 61 177.44 | 24 390 | | | |
| 42 | 2 632 963 | 61 177.44 | 61 278.24 | 24 396 | 11 | 24 396 | |
| 43 | 2 634 643 | 61 278.24 | 61 379.04 | 24 402 | | | |
| 44 | 2 636 323 | 61 379.04 | 61 479.84 | 24 408 | | | |
| 45 | 2 638 003 | 61 479.84 | 61 580.64 | 24 413 | | | |
| 46 | 2 639 683 | 61 580.64 | 61 681.44 | 24 419 | 12 | 24 419 | |
| 47 | 2 641 363 | 61 681.44 | 61 782.24 | 24 425 | 40 | 24 425 | X |
| 48 | 2 643 043 | 61 782.24 | 61 883.04 | 24 431 | | | |
| 49 | 2 644 723 | 61 883.04 | 61 983.84 | 24 437 | | | |
| 50 | 2 646 403 | 61 983.84 | 62 084.64 | 24 443 | 13 | 24 443 | |
| 51 | 2 648 083 | 62 084.64 | 62 185.44 | 24 448 | 41 | 24 448 | X |
| 52 | 2 649 763 | 62 185.44 | 62 286.24 | 24 454 | | | |
| 53 | 2 651 443 | 62 286.24 | 62 387.04 | 24 460 | | | |
| 54 | 2 653 123 | 62 387.04 | 62 487.84 | 24 466 | 14 | 24 466 | |
| 55 | 2 654 803 | 62 487.84 | 62 588.64 | 24 472 | 42 | 24 472 | X |
| 56 | 2 656 483 | 62 588.64 | 62 689.44 | 24 478 | | | |
| 57 | 2 658 163 | 62 689.44 | 62 790.24 | 24 483 | | | |
| 58 | 2 659 843 | 62 790.24 | 62 891.04 | 24 489 | 15 | 24 489 | |
| 59 | 2 661 523 | 62 891.04 | 62 991.84 | 24 495 | 43 | 24 495 | X |
| 60 | 2 663 203 | 62 991.84 | 63 092.64 | 24 501 | | | |
| 61 | 2 664 883 | 63 092.64 | 63 193.44 | 24 507 | | | |
| 62 | 2 666 563 | 63 193.44 | 63 294.24 | 24 513 | 16 | 24 513 | |
| 63 | 2 668 243 | 63 294.24 | 63 395.04 | 24 518 | 44 | 24 518 | X |
| 64 | 2 669 923 | 63 395.04 | 63 495.84 | 24 524 | | | |
| 65 | 2 671 603 | 63 495.84 | 63 596.64 | 24 530 | | | |
| 66 | 2 673 283 | 63 596.64 | 63 697.44 | 24 536 | 17 | 24 536 | |
| 67 | 2 674 963 | 63 697.44 | 63 798.24 | 24 542 | | | |
| 68 | 2 676 643 | 63 798.24 | 63 899.04 | 24 548 | | | |
| 69 | 2 678 323 | 63 899.04 | 63 999.84 | 24 553 | 45 | 24 553 | X |
| 70 | 2 680 003 | 63 999.84 | 64 100.64 | 24 559 | 18 | 24 559 | |
| 71 | 2 681 683 | 64 100.64 | 64 201.44 | 24 565 | | | |
| 72 | 2 683 363 | 64 201.44 | 64 302.24 | 24 571 | | | |
| 73 | 2 685 043 | 64 302.24 | 64 403.04 | 24 577 | 46 | 24 577 | X |
| 74 | 2 686 723 | 64 403.04 | 64 503.84 | 24 583 | 19 | 24 583 | |
| 75 | 2 688 403 | 64 503.84 | 64 604.64 | 24 588 | | | |
| 76 | 2 690 083 | 64 604.64 | 64 705.44 | 24 594 | | | |
| 77 | 2 691 763 | 64 705.44 | 64 806.24 | 24 600 | 47 | 24 600 | X |
| 78 | 2 693 443 | 64 806.24 | 64 907.04 | 24 606 | 20 | 24 606 | |
| 79 | 2 695 123 | 64 907.04 | 65 007.84 | 24 612 | | | |
| 80 | 2 696 803 | 65 007.84 | 65 108.64 | 24 618 | | | |
| 81 | 2 698 483 | 65 108.64 | 65 209.44 | 24 623 | 48 | 24 623 | X |
| 82 | 2 700 163 | 65 209.44 | 65 310.24 | 24 629 | 21 | 24 629 | |
| 83 | 2 701 843 | 65 310.24 | 65 411.04 | 24 635 | | | |
| 84 | 2 703 523 | 65 411.04 | 65 511.84 | 24 641 | | | |
| 85 | 2 705 203 | 65 511.84 | 65 612.64 | 24 647 | 49 | 24 647 | X |
| 86 | 2 706 883 | 65 612.64 | 65 713.44 | 24 653 | 22 | 24 653 | |
| 87 | 2 708 563 | 65 713.44 | 65 814.24 | 24 658 | | | |
| 88 | 2 710 243 | 65 814.24 | 65 915.04 | 24 664 | | | |
| 89 | 2 711 923 | 65 915.04 | 66 015.84 | 24 670 | | | |
| 90 | 2 713 603 | 66 015.84 | 66 116.64 | 24 676 | 23 | 24 676 | |
| 91 | 2 715 283 | 66 116.64 | 66 217.44 | 24 682 | | | |
| 92 | 2 716 963 | 66 217.44 | 66 318.24 | 24 688 | | | |
| 93 | 2 718 643 | 66 318.24 | 66 419.04 | 24 693 | | | |
| 94 | 2 720 323 | 66 419.04 | 66 519.84 | 24 699 | 24 | 24 699 | |
| 95 | 2 722 003 | 66 519.84 | 66 620.64 | 24 705 | | | |
| 96 | 2 723 683 | 66 620.64 | 66 721.44 | 24 711 | | | |
| 97 | 2 725 363 | 66 721.44 | 66 822.24 | 24 717 | | | |
| 98 | 2 727 043 | 66 822.24 | 66 923.04 | 24 723 | 25 | 24 723 | |
| 99 | 2 728 723 | 66 923.04 | 67 023.84 | 24 728 | | | |
| 100 | 2 730 403 | 67 023.84 | 67 124.64 | 24 734 | | | |
| 101 | 2 732 083 | 67 124.64 | 67 225.44 | 24 740 | | | |
| 102 | 2 733 763 | 67 225.44 | 67 326.24 | 24 746 | 26 | 24 746 | |
| 103 | 2 735 443 | 67 326.24 | 67 427.04 | 24 752 | | | |
| 104 | 2 737 123 | 67 427.04 | 67 527.84 | 24 758 | | | |
| 105 | 2 738 803 | 67 527.84 | 67 628.64 | 24 763 | | | |
| 106 | 2 740 483 | 67 628.64 | 67 729.44 | 24 769 | 27 | 24 769 | |
| 107 | 2 742 163 | 67 729.44 | 67 830.24 | 24 775 | | | |
| 108 | 2 743 843 | 67 830.24 | 67 931.04 | 24 781 | | | |
| 109 | 2 745 523 | 67 931.04 | 68 031.84 | 24 787 | | | |
| 110 | 2 747 203 | 68 031.84 | 68 132.64 | 24 793 | 28 | 24 793 | |
| 111 | 2 748 883 | 68 132.64 | 68 233.44 | 24 798 | | | |
| 112 | 2 750 563 | 68 233.44 | 68 334.24 | 24 804 | 50 | 24 804 | X |
| 113 | 2 752 243 | 68 334.24 | 68 435.04 | 24 810 | | | |
| 114 | 2 753 923 | 68 435.04 | 68 535.84 | 24 816 | 29 | 24 816 | |
| 115 | 2 755 603 | 68 535.84 | 68 636.64 | 24 822 | | | |
| 116 | 2 757 283 | 68 636.64 | 68 737.44 | 24 828 | 51 | 24 828 | X |
| 117 | 2 758 963 | 68 737.44 | 68 838.24 | 24 833 | | | |
| 118 | 2 760 643 | 68 838.24 | 68 939.04 | 24 839 | 30 | 24 839 | |
| 119 | 2 762 323 | 68 939.04 | 69 039.84 | 24 845 | | | |
| 120 | 2 764 003 | 69 039.84 | 69 140.64 | 24 851 | 52 | 24 851 | X |
| 121 | 2 765 683 | 69 140.64 | 69 241.44 | 24 857 | | | |
| 122 | 2 767 363 | 69 241.44 | 69 342.24 | 24 863 | 31 | 24 863 | |
| 123 | 2 769 043 | 69 342.24 | 69 443.04 | 24 868 | | | |
| 124 | 2 770 723 | 69 443.04 | 69 543.84 | 24 874 | 53 | 24 874 | X |
| 125 | 2 772 403 | 69 543.84 | 69 644.64 | 24 880 | | | |
| 126 | 2 774 083 | 69 644.64 | 69 745.44 | 24 886 | 32 | 24 886 | |
| 127 | 2 775 763 | 69 745.44 | 69 846.24 | 24 892 | | | |
| 128 | 2 777 443 | 69 846.24 | 69 947.04 | 24 898 | 54 | 24 898 | X |
| 129 | 2 779 123 | 69 947.04 | 70 047.84 | 24 903 | | | |
| 130 | 2 780 803 | 70 047.84 | 70 148.64 | 24 909 | 33 | 24 909 | |
| 131 | 2 782 483 | 70 148.64 | 70 249.44 | 24 915 | | | |
| 132 | 2 784 163 | 70 249.44 | 70 350.24 | 24 921 | | | |
| 133 | 2 785 843 | 70 350.24 | 70 451.04 | 24 927 | | | |
| 134 | 2 787 523 | 70 451.04 | 70 551.84 | 24 933 | 34 | 24 933 | |
| 135 | 2 789 203 | 70 551.84 | 70 652.64 | 24 938 | | | |
| 136 | 2 790 883 | 70 652.64 | 70 753.44 | 24 944 | | | |
| 137 | 2 792 563 | 70 753.44 | 70 854.24 | 24 950 | | | |
| 138 | 2 794 243 | 70 854.24 | 70 955.04 | 24 956 | | | |

When the first example of proposal and the second example of proposal are compared, the following descriptions may be derived:

Channel raster type of the first example of proposal may be floating. Channel raster type of the second example of proposal may be fixed.

Channel raster may be based on 960 kHz spacing for the first example of proposal. For the second example of proposal, Channel raster may be based on 100.8 MHz for 100 MHz CBW, and raster steps for wider CBWs are multiples of 100.8 MHz.

Flexibility to support different intra-band CA combinations may be high for both of the first example of proposal and the second example of proposal. It may be very high for the first example of proposal.

For the first example of proposal, 120 kHz SCS SSB raster is fixed. One SSB is configured per 100 MHz. 140 locations may be used for SSB raster. For the second example of proposal, 120 kHz SCS SSB raster is fixed. One SSB is configured per 100.8 MHz. 138 locations may be used for SSB raster.

For the first example of proposal, 120 kHz SCS SSB raster is fixed. One SSB is configured per 400 MHz. 70 locations may be used for SSB raster. For the second example of proposal, 480 kHz SCS SSB raster is fixed. One SSB is configured per 400 MHz. 54 locations may be used for SSB raster.

Both of the first example of proposal and the second example of proposal may be possibly aligned with Wi-Fi standard 802.11.

### 3. Third Example of the Present Disclosure

Third example of the present disclosure explains operations of a UE and/or a base station according to examples of the first example of the present disclosure and/or the examples of the second example of the present disclosure.

In LTE sync and channel raster were the same as sync raster was also at the center of the channel

In NR the sync channel (SSB) can be also in other location within the channel (not only in the center) and therefore UE needs to be told the center frequency of the channel. This is done by configuring the UE to use certain NR-ARFCN.

In other words, when UE finds SSB (by scanning though list of frequencies stored into UE) the frequency of the SSB does not directly indicate the center frequency for the channel. This information is signalled to UE as NR-ARFCN, which is then used to calculate the center frequency for the channel where NW wants UE to operate.

The following drawings are prepared to explain a specific example of the present specification. Since the names of specific devices or names of specific signals/messages/fields described in the drawings are provided by way of example, technical features of the present specification are not limited to specific names used in the following drawings.

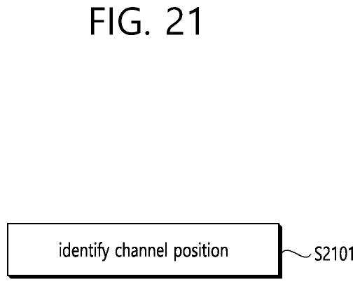

FIG. 21 illustrates aa example of operations of a UE according to an embodiment of the present disclosure.

FIG. 21 shows an example of operations of the UE. UE may perform operations described in the present specification, even if they are not shown in FIG. 21. Herein, a network may be gNB, base station, serving cell, etc.

FIG. 21 may show examples of an operation of the UE based on descriptions of First Example to Second Example of the disclosure of the present specification.

In step S1301, the UE may identify channel position based on RF reference frequency in operating band n263. For example, the UE may identify Radio Frequency (RF) channel position based on RF reference frequency in operating band n263. The RF reference frequency may be defined by channel raster. The channel raster may be based on applicable New Radio Absolute Radio Frequency Channel Number (NR-ARFCN) within the operating band n263. The applicable NR-ARFCN in the operating band n263 may be based on channel bandwidth. Based on that channel bandwidth is 400 MHz, 800 MHz, 1600 MHz, or 2000 MHz for the operating band n263, the applicable NR-ARFCN may include one or more of NR-ARFCNs being spaced apart each other by 6720*N. N may be an integer.

For example, RF channel position may be used, by the UE and/or a base station, to identify RF position based on RF reference frequency in operating band n263. Channel raster may define a subset of RF reference frequencies that can be used to identify the RF channel position in uplink and downlink. RF channel positions on the channel raster in each NR operating band may be given through the applicable NR-ARFCN in the example of table 21. The applicable NR-ARFCN in the operating band n263 is based on channel bandwidth, which is one of 400 MHz, 800 MHz, 1600 MHz, or 2000 MHz. Based on that channel bandwidth is 400 MHz, 800 MHz, 1600 MHz, or 2000 MHz for the operating band n263, the applicable NR-ARFCN may include one or more of NR-ARFCNs as shown in NOTE 1 of Table 21.

For example, Applicable NR-ARFCN for band n263 for 400 MHz channel bandwidth, N_{REF} may be at least one of {2566603, 2573323, 2580043, 2586763, 2593483, 2600203, 2606923, 2613643, 2620363, 2627083, 2633803, 2640523, 2647243, 2653963, 2660683, 2667403, 2674123, 2680843, 2687563, 2694283, 2701003, 2707723, 2714443, 2721163, 2727883, 2734603, 2741323, 2748043, 2754763, 2761483, 2768203, 2774923, 2781643, 2788363, 2571643, 2578363, 2585083, 2591803, 2598523, 2642203, 2648923, 2655643, 2662363, 2669083, 2679163, 2685883, 2692603, 2699323, 2706043, 2751403, 2758123, 2764843, 2771563, 2778283}.

For example, Applicable NR-ARFCN for band n263 for 800 MHz channel bandwidth, N_{REF} may be at least one of {2569963, 2576683, 2583403, 2590123, 2596843, 2603563, 2610283, 2617003, 2623723, 2630443, 2637163, 2643883, 2650603, 2657323, 2664043, 2670763, 2677483, 2684203, 2690923, 2697643, 2704363, 2711083, 2717803, 2724523, 2731243, 2737963, 2744683, 2751403, 2758123, 2764843, 2771563, 2778283, 2785003, 2575003, 2581723, 2588443, 2595163, 2645563, 2652283, 2659003, 2665723, 2682523, 2689243, 2695963, 2702683, 2754763, 2761483, 2768203, 2774923}.

For example, Applicable NR-ARFCN for band n263 for 1600 MHz channel bandwidth, N_{REF} may be at least one of {2576683, 2590123, 2603563, 2617003, 2630443, 2643883, 2657323, 2670763, 2684203, 2697643, 2711083, 2724523, 2737963, 2751403, 2764843, 2778283, 2581723, 2623723, 2652283, 2695963, 2724523, 2768203}.

For example, Applicable NR-ARFCN for 2000 MHz channel bandwidth, N_{REF} may be at least one of {2576683, 2603563, 2610283, 2637163, 2643883, 2670763, 2677483, 2704363, 2711083, 2737963, 2744683, 2771563, 2585083, 2620363, 2655643, 2692603, 2727883, 2764843}.

RF channel positions on channel raster in each NR operating band, e.g. operating band n263, may be given through the applicable NR-ARFCN in Table 21. Channel raster may define RF reference frequencies that can be used to identify the RF channel position in uplink and downlink For example, RF channel position may be used, by the UE and/or a base station, to identify RF position based on RF reference frequency in operating band n263. Channel raster defines a set of RF reference frequencies that define the RF channel position in uplink and downlink. RF channel positions on the channel raster in each NR operating band may be given through the applicable NR-ARFCN in the example of table 21. The applicable NR-ARFCN in the operating band n263 is based on channel bandwidth, which is one of 400 MHz, 800 MHz, 1600 MHz, or 2000 MHz. Based on that channel bandwidth is 400 MHz, 800 MHz, 1600 MHz, or 2000 MHz for the operating band n263, the applicable NR-ARFCN may include one or more of NR-ARFCNs as shown in NOTE 1 of Table 21.

For example, all or some of the applicable NR-ARFCN shown in Table 21 may expressed as the following. Based on that channel bandwidth is 400 MHz for the operating band n263, the applicable NR-ARFCN may be equal to 2566603+6720*N. For example, for channel bandwidth of 400 MHz, 2566603, 2573323, 2580043, 2586763, 2593483, 2600203, 2606923, 2613643, 2620363, 2627083, 2633803, 2640523, 2647243, 2653963, 2660683, 2667403, 2674123, 2680843, 2687563, 2694283, 2701003, 2707723, 2714443, 2721163, 2727883, 2734603, 2741323, 2748043, 2754763, 2761483, 2768203, 2774923, 2781643, 2788363, 2571643, 2578363, are spaced apart from each other as multiple of 6720 (6720*N). Based on that channel bandwidth is 800 MHz for the operating band n263, the applicable NR-ARFCN may be equal to 2569963+6720*N. For example, for channel bandwidth of 800 MHz, 2569963, 2576683, 2583403, 2590123, 2596843, 2603563, 2610283, 2617003, 2623723, 2630443, 2637163, 2643883, 2650603, 2657323, 2664043, 2670763, 2677483, 2684203, 2690923, 2697643, 2704363, 2711083, 2717803, 2724523, 2731243, 2737963, 2744683, 2751403, 2758123, 2764843, 2771563, 2778283, 2785003, are spaced apart from each other as multiple of 6720 (6720*N). Based on that channel bandwidth is 1600 MHz for the operating band n263, the applicable NR-ARFCN may be equal to 2576683+6720*N. For example, for channel bandwidth of 1600 MHz, 2576683, 2590123, 2603563, 2617003, 2630443, 2643883, 2657323, 2670763, 2684203, 2697643, 2711083, 2724523, 2737963, 2751403, 2764843, 2778283 are spaced apart from each other as multiple of 13440, which is twice of 6720, (thus, 6720*N).

The UE may perform communication with the base station based on a channel including the identified RF channel position. Center frequency of the configured channel for the UE may be same as the identified RF channel position.

The base station may may configure channel position based on RF reference frequency in operating band n263. For example, the UE may identify Radio Frequency (RF) channel position based on RF reference frequency in operating band n263. The RF reference frequency may be defined by channel raster. The channel raster may be based on applicable New Radio Absolute Radio Frequency Channel Number (NR-ARFCN) within the operating band n263. The applicable NR-ARFCN in the operating band n263 may be based on channel bandwidth. Based on that channel bandwidth is 400 MHz, 800 MHz, 1600 MHz, or 2000 MHz for the operating band n263, the applicable NR-ARFCN may include one or more of NR-ARFCNs being spaced apart each other by 6720*N. N may be an integer.

The UE and/or the base station may further perform random access procedure based on the received SS block. For example, the random access procedure may be performed based on examples shown in FIG. 4 to FIG. 10.

According to some embodiment of the present disclosure, the UE may identify channel position based on RF reference frequency in operating band n263. For example, the UE may identify Radio Frequency (RF) channel position based on RF reference frequency in operating band n263. The RF reference frequency may be defined by channel raster. The channel raster may be based on applicable New Radio Absolute Radio Frequency Channel Number (NR-ARFCN) within the operating band n263. The applicable NR-ARFCN in the operating band n263 may be based on channel bandwidth. Based on that channel bandwidth is 400 MHz, 800 MHz, 1600 MHz, or 2000 MHz for the operating band n263, the applicable NR-ARFCN may include one or more of NR-ARFCNs being spaced apart each other by 6720*N. N may be an integer.

Hereinafter, an apparatus(for example, UE) in a wireless communication system, according to some embodiments of the present disclosure, will be described.

For example, the apparatus may include at least one processor, at least one transceiver, and at least one memory.

For example, the at least one processor may be configured to be coupled operably with the at least one memory and the at least one transceiver.

For example, the processor may be configured to perform operations explained in various examples of the present specification. For example, the processor may be configured to perform operations including: identifying channel position based on RF reference frequency in operating band n263. For example, the UE may identify Radio Frequency (RF) channel position based on RF reference frequency in operating band n263. The RF reference frequency may be defined by channel raster. The channel raster may be based on applicable New Radio Absolute Radio Frequency Channel Number (NR-ARFCN) within the operating band n263. The applicable NR-ARFCN in the operating band n263 may be based on channel bandwidth. Based on that channel bandwidth is 400 MHz, 800 MHz, 1600 MHz, or 2000 MHz for the operating band n263, the applicable NR-ARFCN may include one or more of NR-ARFCNs being spaced apart each other by 6720*N. N may be an integer.

Hereinafter, a processor for in a wireless communication system, according to some embodiments of the present disclosure, will be described.

For example, the processor may be configured to perform operations including: identifying channel position based on RF reference frequency in operating band n263. For example, the UE may identify Radio Frequency (RF) channel position based on RF reference frequency in operating band n263. The RF reference frequency may be defined by channel raster. The channel raster may be based on applicable New Radio Absolute Radio Frequency Channel Number (NR-ARFCN) within the operating band n263. The applicable NR-ARFCN in the operating band n263 may be based on channel bandwidth. Based on that channel bandwidth is 400 MHz, 800 MHz, 1600 MHz, or 2000 MHz for the operating band n263, the applicable NR-ARFCN may include one or more of NR-ARFCNs being spaced apart each other by 6720*N. N may be an integer.

Hereinafter, a non-transitory computer-readable medium has stored thereon a plurality of instructions in a wireless communication system, according to some embodiments of the present disclosure, will be described.

According to some embodiment of the present disclosure, the technical features of the present disclosure could be embodied directly in hardware, in a software executed by a processor, or in a combination of the two. For example, a method performed by a wireless device in a wireless communication may be implemented in hardware, software, firmware, or any combination thereof. For example, a software may reside in RAM memory, flash memory, ROM memory, EPROM memory, EEPROM memory, registers, hard disk, a removable disk, a CD-ROM, or any other storage medium.

Some example of storage medium is coupled to the processor such that the processor can read information from the storage medium. In the alternative, the storage medium may be integral to the processor. The processor and the storage medium may reside in an ASIC. For other example, the processor and the storage medium may reside as discrete components.

The computer-readable medium may include a tangible and non-transitory computer-readable storage medium.

For example, non-transitory computer-readable media may include random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, or any other medium that can be used to store instructions or data structures. Non-transitory computer-readable media may also include combinations of the above.

In addition, the method described herein may be realized at least in part by a computer-readable communication medium that carries or communicates code in the form of instructions or data structures and that can be accessed, read, and/or executed by a computer.

According to some embodiment of the present disclosure, a non-transitory computer-readable medium has stored thereon a plurality of instructions.

For example, the stored a plurality of instructions may be executed by a processor of a UE to perform operations including: identifying channel position based on RF reference frequency in operating band n263. For example, the UE may identify Radio Frequency (RF) channel position based on RF reference frequency in operating band n263. The RF reference frequency may be defined by channel raster. The channel raster may be based on applicable New Radio Absolute Radio Frequency Channel Number (NR-ARFCN) within the operating band n263. The applicable NR-ARFCN in the operating band n263 may be based on channel bandwidth. Based on that channel bandwidth is 400 MHz, 800 MHz, 1600 MHz, or 2000 MHz for the operating band n263, the applicable NR-ARFCN may include one or more of NR-ARFCNs being spaced apart each other by 6720*N. N may be an integer.

Advantageous effects which can be obtained through specific embodiments of the present disclosure. For example, the RF channel position for performing communication based on operating band n263 are efficiently defined and do not generate unnecessary burden for UE implementation. For example, the present disclosure may define mandatory function for FR2-2 n263 for 400, 800, 1600 and 2000 MHz CBW. For example, a way to define channel raster grid for above mentioned CBWs for FR2-2 n263 band, which is based on the general channel raster grid is proposed.

In the above exemplary systems, although the methods have been described on the basis of the flowcharts using a series of the steps or blocks, the present disclosure is not limited to the sequence of the steps, and some of the steps may be performed at different sequences from the remaining steps or may be performed simultaneously with the remaining steps. Furthermore, those skilled in the art will understand that the steps shown in the flowcharts are not exclusive and may include other steps or one or more steps of the flowcharts may be deleted without affecting the scope of the present disclosure.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

Claims in the present disclosure can be combined in a various way. For instance, technical features in method claims of the present disclosure can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method. Other implementations are within the scope of the following claims.

The invention claimed is:

1. A user equipment (UE) operating in a wireless communication system, the UE comprising:
at least one transceiver;
at least one processor; and
at least one computer memory operably connectable to the at least one processor and storing instructions that, based on being executed by the at least one processor, perform operations comprising:
identifying Radio Frequency (RF) channel position based on RF reference frequency in operating band n263,
wherein the RF reference frequency is defined by channel raster,
wherein the channel raster is based on applicable New Radio Absolute Radio Frequency Channel Number (NR-ARFCN) within the operating band n263,
wherein the applicable NR-ARFCN in the operating band n263 is based on channel bandwidth,
based on that channel bandwidth is 400 MHz, 800 MHz, or 1600 MHz for the operating band n263, the applicable NR-ARFCN includes one or more of NR-ARFCNs being spaced apart each other by 6720*N, and
wherein N is an integer.

2. The UE of claim 1,
wherein the RF reference frequency is equal to:
$${F}_{REF - Offs} + Δ {F}_{Global} * ( {N}_{REF} - {N}_{REF - Offs} ) ,$$
wherein the F_{REF-Offs} is equal to 24250.08 MHz,
wherein the ΔF_{Global} is equal to 60 kHz,
wherein the N_{REF} is the applicable NR-ARFCN, and
wherein the N_{REF-Offs} is equal to 2016667.

3. The UE of claim 1,
based on that channel bandwidth is 400 MHz for the operating band n263, and
wherein the applicable NR-ARFCN is equal to 2566603+6720*N.

4. The UE of claim 1,
based on that channel bandwidth is 800 MHz for the operating band n263, and
wherein the applicable NR-ARFCN is equal to 2569963+6720*N.

5. The UE of claim 1,
based on that channel bandwidth is 1600 MHz for the operating band n263, and
wherein the applicable NR-ARFCN is equal to 2576683+6720*N.

6. The UE of claim 1, wherein the operations further comprise:
performing communication based on a channel including the identified RF channel position.

7. A method for performing communication, the method performed by a user equipment (UE), the method comprising:
identifying Radio Frequency (RF) channel position based on RF reference frequency in operating band n263,
wherein the RF reference frequency is defined by channel raster,
wherein the channel raster is based on applicable New Radio Absolute Radio Frequency Channel Number (NR-ARFCN) within the operating band n263,
wherein the applicable NR-ARFCN in the operating band n263 is based on channel bandwidth,
based on that channel bandwidth is 400 MHz, 800 MHz, or 1600 MHz for the operating band n263, the applicable NR-ARFCN includes one or more of NR-ARFCNs being spaced apart each other by 6720*N, and
wherein N is an integer.

8-11. (canceled)

12. The method of claim 7,
wherein the RF reference frequency is equal to:
$${F}_{REF - Offs} + Δ {F}_{Global} * ( {N}_{REF} - {N}_{REF - Offs} ) ,$$
wherein the F_{REF-Offs} is equal to 24250.08 MHz,
wherein the ΔF_{Global} is equal to 60 kHz,
wherein the N_{REF} is the applicable NR-ARFCN, and
wherein the N_{REF-Offs} is equal to 2016667.

13. The method of claim 7,
based on that channel bandwidth is 400 MHz for the operating band n263, and
wherein the applicable NR-ARFCN is equal to 2566603+6720*N.

14. The method of claim 7,
based on that channel bandwidth is 800 MHz for the operating band n263, and
wherein the applicable NR-ARFCN is equal to 2569963+6720*N.

15. The method of claim 7,
based on that channel bandwidth is 1600 MHz for the operating band n263, and
wherein the applicable NR-ARFCN is equal to 2576683+6720*N.

16. The method of claim 7, wherein the operations further comprise:
performing communication based on a channel including the identified RF channel position.

17. A method for performing communication, the method performed by a base station, the method comprising:
configuring Radio Frequency (RF) channel position for a channel, which is used for communicating with a User Equipment (UE), based on RF reference frequency in operating band n263,
wherein the RF reference frequency is defined by channel raster,
wherein the channel raster is based on applicable New Radio Absolute Radio Frequency Channel Number (NR-ARFCN) within the operating band n263,
wherein the applicable NR-ARFCN in the operating band n263 is based on channel bandwidth,
based on that channel bandwidth is 400 MHz, 800 MHz, or 1600 MHz for the operating band n263, the applicable NR-ARFCN includes one or more of NR-ARFCNs being spaced apart each other by 6720*N, and
wherein N is an integer.

18. The method of claim 17,
wherein the RF reference frequency is equal to:
$${F}_{REF - Offs} + Δ {F}_{Global} * ( {N}_{REF} - {N}_{REF - Offs} ) ,$$
wherein the F_{REF-Offs} is equal to 24250.08 MHz,
wherein the ΔF_{Global} is equal to 60 kHz,
wherein the N_{REF} is the applicable NR-ARFCN, and
wherein the N_{REF}-Offs is equal to 2016667.
